(19) United States
(12) Patent Application Publication
(10) Pub. No.: US 2003/0043144 A1
(43) Pub. Date: Mar. 6, 2003

(54) Organizing and interactively accessing information

(76) Inventors: Eshwarahalli Sundararajan Pundarika, New York, NY (US); Eshwarahalli Sundararajan Purandara Das, New York, NY (US); Sriram Purandara Das, New York, NY (US); Vasanta Bhairavi Pundarika, New York, NY (US)

Correspondence Address: CHRISTIE, PARKER & HALE, LLP, 350 WEST COLORADO BOULEVARD, SUITE 500, PASADENA, CA, 91105, US

(21) Appl. No.: 09/838,524

(22) Filed: Apr. 18, 2001

Related U.S. Application Data
(60) Provisional application No. 60/198,106, filed on Apr. 18, 2000.

(51) Int. Cl. G06T 15/00

(52) U.S. Cl. 345/419

(57) ABSTRACT

A system and method for organizing and interactively accessing information within a virtual three dimensional computing environment is disclosed. The system moves beyond the “page” concept of web browsing and recreates a realistic user experience. In one aspect, products are depicted in a three dimensional computing environment that simulates a brick-and-mortar store, whereby the user may navigate through the environment and click on individual products to focus on the product and obtain additional information. The system may be applied in an e-commerce setting, in an e-community setting or other settings, for example, on an interactive basis over a computer network-implemented system.

### CROSS-REFERENCE TO RELATED APPLICATION(S)

This application claims the benefit of U.S. Provisional Patent Application No. 60/198,106, filed on Apr. 18, 2000, entitled ORGANIZING AND INTERACTIVELY ACCESSING INFORMATION, the contents of which are incorporated herein by reference.

### FIELD OF THE INVENTION

This invention relates generally to enhancing user experience on the Internet, in an e-commerce setting, in an e-community setting or other settings, for example, on an interactive basis over a computer network-implemented system.

### BACKGROUND

Most of the e-commerce sites of today do on focus on creating a rich user experience on-line and limit themselves to being able to deliver a list of things fast on a slow modem. This is quite surprising given that we are moving to an experience economy where value is placed on user experience rather than on service. We are willing to wait in line and pay $30 to experience the rides at Disneyland. We willingly pay $3 for a soft drink at a nice Italian restaurant with a nice ambieance while balk at the 99¢ we need to pay for the efficiently prepared hamburger at McDonalds®, which offers the very same standardized service at all its stores. We no longer place high value on mere service, just like we changed our allegiance form manufacturing to service economy in the earlier epoch. We now expect and value a wonderful experience that is staged for us. And we like this experience to be personalized.

The Internet is perfectly set for delivering this sort of experience in the most efficient fashion. However, today, this experience is very restricted, limited to the experience of “convenience,”—the ability to order a commodity on the Internet from the comfort of one's home. Some sites have added a few features to differentiate themselves from a pure price play. So far, generally, the focus ha not been on giving the user a rich experience to make him linger longer at the site, but rather on making a quick sale—such as efficient search engines that look for the items needed by the user in seconds. We describe below some embodiments of our invention that enrich the Internet experience focusing on having the customer spend more time at the site (rather than buy and get out quickly). Aspects of our invention take personalization to a new level and enable several kinds of mass currently exist anywhere on the Internet. While our invention applies to all e-commerce and experience creation on the Internet, for simplicity we describe below some of the features of the invention as applied to books on the Internet. We have generally taken the approach of getting the best of the experience from the brick and mortar world and augment the experience using computer/Internet capabilities.

### SUMMARY

We have invented a process for enriching the Internet experience for e-commerce businesses such as bookstores, clothing stores, grocery stores, as well as for museums, libraries, book clubs, video libraries, etc.

The rich experience is created by first moving beyond the “page” concept of the web pages to recreate the essential features of a real worked experience, and by enhancing this experience by utilizing the power of the computer/Internet. Unshackling our thinking from the chains of web page orientation is truly liberating and can unleash tremendous creativity.

### BRIEF DESCRIPTION OF THE DRAWINGS

The teachings of the present invention can be readily understood by considering the following detailed description in conjunction with the accompanying drawings.

FIGS. 1A-43 illustrate flowcharts outlining processes in accordance with several embodiments of the invention.

Illustration 1-21 in the attached Appendix show, in some cases schematically, displays and applications corresponding to processes in accordance with several embodiments of the invention.

### DETAILED DESCRIPTION

For the sake of specificity, but without loss of generality, the following description is couched in terms of an e-commerce site for books in order to make the descriptions more concrete, although the inventive subject matter itself applies to any e-commerce opportunity, as well as other interactive, computer-based settings.

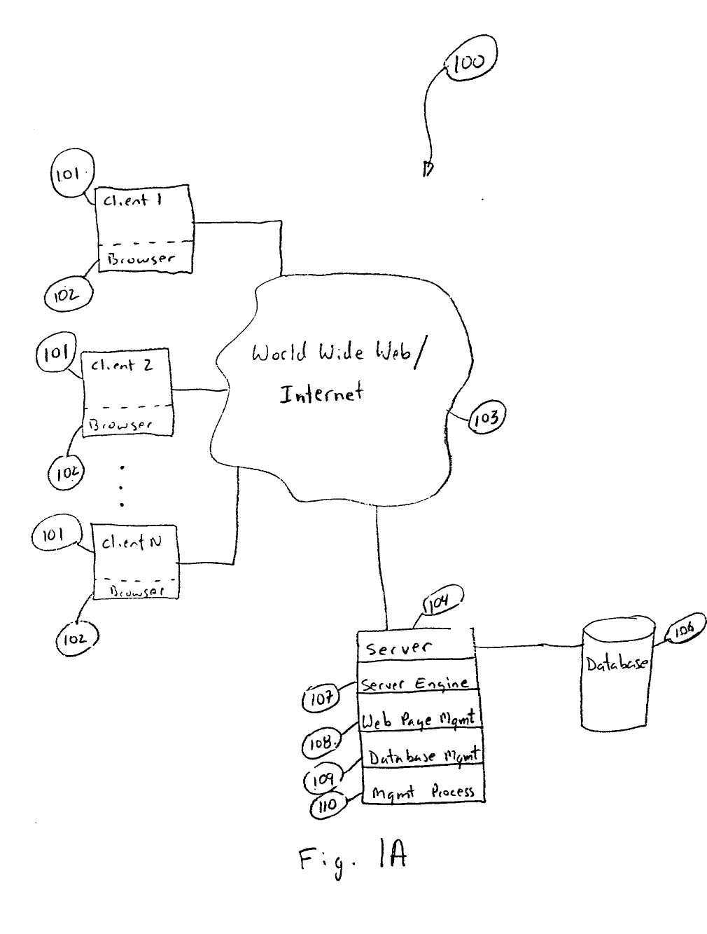

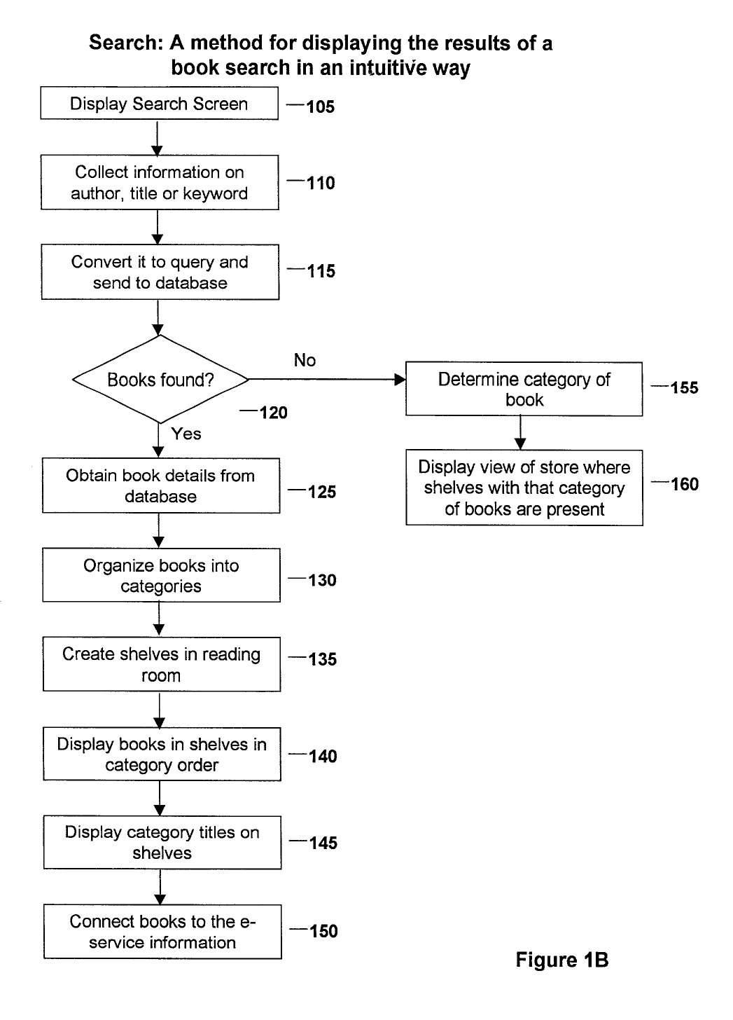

FIG. 1A and the following discussion provide a brief, general description of a suitable computing environment in which the invention can be implemented. Although not required, the embodiments of the invention will be described in the general context of computer-executable instructions, for example, routines executed by a general-purpose computer, such as a personal computer. Those skilled in the relevant art will appreciate that the invention can be practiced with other computer system configurations, including Internet appliances, hand-held devices, cellular phones, multiprocessor systems, multiprocessor-based or programmable consumer electronics, network PCs, minicomputers, mainframe computers, and the like. The invention can be embodied in a specific-purpose computer or data processor that is specifically programmed, configured or constructed to perform one or more of the computer-executable instructions explained in detail below. The invention can also be practiced in distributed computing environments where tasks or modules are performed by remote processing devices, which are linked through a communications network. In a distributed computing environment, program modules or subroutines may be located in both local and remote memory storage devices. In general, while hardware platforms, such as terminals and controllers, are described herein, aspects of the invention are equally applicable to nodes on the network having corresponding resource locators to identify such nodes.

Unless described otherwise, the construction and operation of the various blocks shown in FIG. 1A are of conventional design. As a result, such blocks need not be described in further detail herein, as they will be readily understood by those skilled in the relevant art.

Referring to FIG. 1A, a system 100 in accordance with an embodiment of the invention includes one or more client computers 101, each of which includes a browser program module 102 that permits the computer to access and exchange data with the Internet, including web sites within a World Wide Web (“Web”) portion 103 of the Internet. The client computers 101 may include one or more central processing units or other logic processing circuitry, memory, input devices (e.g., keyboards and pointing devices), output devices (e.g., display devices and printers), and storage devices (e.g., fixed, floppy and optical disk drives, magnetic cassettes, flash memory cards, digital video disks (DVDs), Bernoulli cartridges, RAMs, ROMs, smart cards, etc.), all well known but not shown in FIG. 1. The client computers 101 may also include other program modules, such as an operating system, one or more application programs (e.g., word processing or spread sheet applications), and the like. The client computers 101 can be operated by a user such as a customer or potential customer of goods and senrices, for example, books or groceries.

A server computer 104, coupled to the Web 103, performs much or all of the organizing, accessing, and display processes. A database 106, coupled to the server computer 104, stores much of the data exchanged between the client computers 101, and the server computer 104, as described below.

The server computer 104 includes a server engine 107, a web page management component 108, a database management component 109, a management process component 110, as well as other components not shown in FIG. 1. As described more fully below, the server engine 107, the web page management component 108, the database management component 109, and the management process component 110 operate together to retrieve information from the database 106 and provide the information to the client computers 101. In one embodiment, the server computer 104 and the database 106 can form a single computing platform. Alternatively, the functions performed by the server computer 104 and/or the database 106 can be distributed over a plurality of platforms.

In other embodiments, the system 100 can be incorporated in contexts other than the Internet, such as other distributed computing environments, or stand-alone computing environments. For example, the system 100 can be incorporated into a kiosk placed in a bookstore, museum, airport, or other location). Alternatively, the system 100 can be incorporated into a device installed on an airliner, allowing passengers to watch a movie, view and/or listen to a book, or browse through a store. The system 100 can also include programs directed to children, such as a compilation of Dicken's works or an explorable bible.

In one embodiment, our business process creatively combines the “positive” experiences of the consumer in a brick and mortar store with the power of the computer/Internet with a view to creating a very desirable experience for the consumer on the Internet. Illustration 1 schematically depicts an embodiment of a method for simulating experiencing a store in three dimensions on a two-dimensional computer screen. This combination, on the one hand, allows immediate application to our Internet store the decades of experience gained at real stores. On the other hand, the power of the computer/Internet can now be applied in ways never thought of or possible with the page orientation. There are many aspects of the real (e.g., bricks and mortar) bookstore that are absent in today's on-line bookstores. Illustration 5 schematically depicts some of the features of a bricks and mortar store. For example, the hundreds of books the visitor sees as he enters a bricks and mortar store are organized into categories and groupings, making it easy for the visitor to go straight to the section he wants to browse. The visitor can discover the books as he browses through the shelves and can thumb through the books he picks up from the shelves. The visitor or user finds an information desk ever ready to help him find a book. Overall, the experience in the real bookstore is enough to make the visitor want to come back and browse books again.

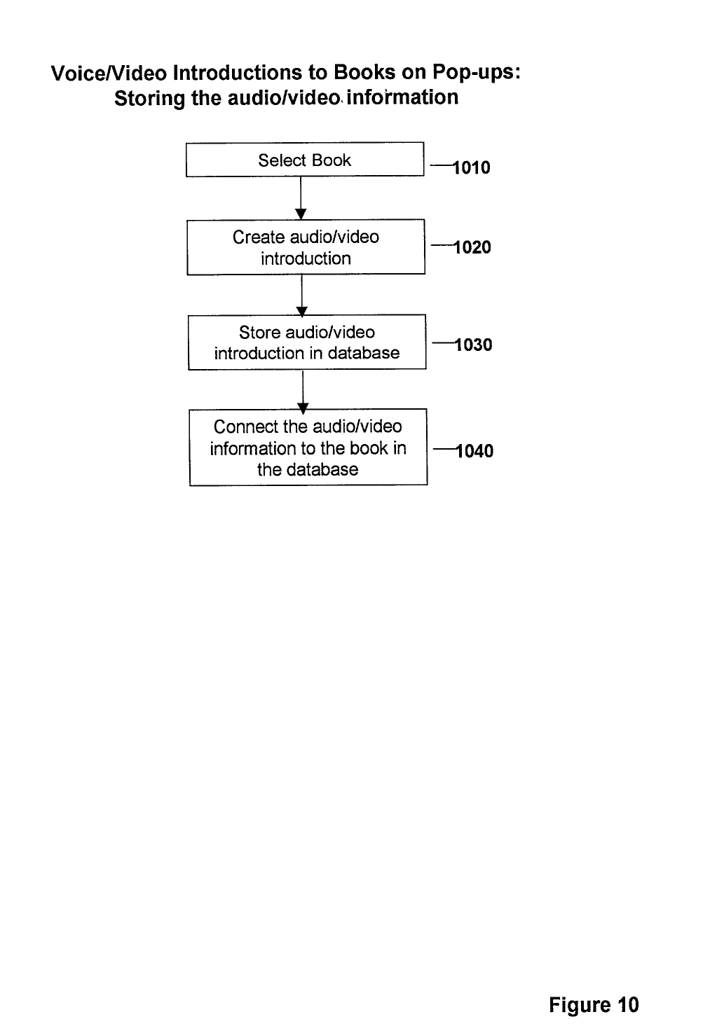

Our approach is basically to recreate on the web the essential features of these experiences as well as enhancing them using the power of the computer/Internet to deliver a truly rich user experience. For instance, in one embodiment, a three dimensional store is represented on the Web. Illustration 6 shows a web page on a computer screen that displays the interior of a book store and highlights some of the features of the display, in accordance with an embodiment of the invention. For example, the display can include hundreds of books, arranged by theme and individually browsable. The display can include an information desk with links to helpful information. The visitor is able to navigate through the store with books displayed in shelves similar to the real bookstore. For example, Illustrations 7-8 show additional web pages displayed to the visitor as the visitor “moves” through the bookstore, for example, by entering commands at the computer keyboard. Alternatively, the visitor can use a head-mounted “virtual reality” display or other display device. In either embodiment, the visitor can navigate intuitively through the store and discover books, pick up a book from the shelves and view several pages in the book. For example, Illustration 9 shows a page displayed to the viewer as the viewer navigates an approach to a shelf of books. FIG. 10 shows a page of available by clicking on one of the books displayed. The user can also activate a help button that will work similar to a help desk. One embodiment of our invention includes a process to make the book pages realistic on the screen by introducing a curvature to the pages of the book to make them appear like they would in the real world. For example, Illustration 13 shows a screen display of an opened book with the text on each page appearing to conform to a curved plane. In one aspect of this embodiment, the display can include a moveable magnification window or lens that the visitor can move over the pages to magnify selected portions of the pages as he reads.

We enhance this real-store like experience by adding functionality not possible in the brick and mortar store. For example, in another embodiment, the visitor can choose music that plays while he is in our store. In still another embodiment, the system includes a search facility that creates new shelves of books based on the results of the search. For example, Illustration 14 shows a screen display of sections of books related to a visitor's search query. In yet another embodiment, the system can include a facility to search for a phrase or word from the whole book collection, a facility to ask a question and have it answered based on the contents of a selection of books, a facility that rearranges the books in a shelf from say author order to title order, a facility that customizes the books displayed in the bookstore based on the interests of the user, a facility that allows a user to create his own section of the bookstore where he can store the books that he has purchased or wants to purchase or wants to have there for whatever reason, a facility that allows a user to add audio reviews of books that other users can listen to, a facility that allows a user to record a book or a section in his own voice, and/or a facility to instantly create a whole collection of books on a topic or topics of choice. In one embodiment, the system can include a facility to have the books read to the user (Illustrations 19-20). For example, children can listen to an audio rendition of a story while following along with a hard copy (or computer screen based version) of the story, as shown in Illustration 15. The audio rendition can include sound effects corresponding to action in the story and/or audio branding. Younger children can listen to an audio rendition without following text, as shown in Illustration 16. In another aspect of this embodiment, a user can listen to cooking instructions while preparing a dish, and can control the pace of the instructions, as shown in Illustration 17. The system can display video clips of portions of the cooking process, or the entire process and can automatically adjust the amount of each ingredient in the recipe, based on the user's selected number of servings, as shown in Illustration 18. As is also shown in Illustration 18, the system can include automatic timers set by the user to time phases of the cooking process.

In still another embodiment, users can rent audio renditions of a book and listen to the book in several installments, each time picking up where the audio was last halted, as shown in Illustration 19. In another aspect of this embodiment, the user can pre-program the audio renditions to begin and end at selected times, as shown in Illustration 20.

In further embodiments, the system can include a facility for users to create their own libraries, a facility for users to share parts of their libraries with their friends by allowing them to visit, a facility for friends from distant parts of the country or the world to visit the store at the same time and share their book findings, a facility for users to recommend books to others, a facility for displaying video libraries and clips of videos, and/or a facility for creating on-line communities.

An embodiment of our invention also allows the owner of the bookstore many facilities not possible in a brick and mortar bookstore. For instance, in one embodiment, the system can include a facility to collect information about the books that the customer has seen or purchased, recommended etc., and/or a facility to instantly create displays based on themes, such as Kennedy family books display at the time of John F. Kennedy, Jr.'s death, as shown in Illustration 11. In other embodiments, the system can include a facility to store these displays for instant retrieval as needed, a facility to enhance customer's experience by adding movie video clips or music to the book browsing experience, a facility to change the bookstore contents and arrangement easily, a facility to create multiple bookstores for different purposes, a facility to create themed display rooms with corresponding links to other relevant sites (for example, a travel site link from a display of books on Italy), a facility to naturally show advertisements to the visitors, a facility to draw customers to the store by presenting advertisements that could result in a free gift to the customer, a facility to print books out of print or out of copyright as and when the customer requests it, and/or a facility to personalize the books that are printed for each customer.

An embodiment of our invention also allows providing these facilities to libraries. The libraries can place their entire collections on the Internet with our invention in an organized fashion that anyone can search in an intuitive fashion. Again, things that are not possible in a general library will be possible in this library such as rearrangement of books, display of books available at other libraries, creation of individualized research collections etc. Any visitors to the on-line library can then order books directly from the library through a link. They can order single copies of out of print or out of copyright books.

An embodiment of our invention allows the creation of a catalog room that will have the catalogs from many stores. These catalogs will combine the real catalog experience with the power of the computer and make the catalog searchable. The viewers can browse through the catalog, view a demonstration if available, and order directly whatever they want. An entire big mall can now be available in a shelf full of catalogs.

An embodiment of what we have invented takes the real power of the Internet—instant access to vast amounts of information—and takes it to a much higher level. We present a huge amount of information is a very small space with very intuitive organization and structure that makes all this information truly accessible. Our invention is useable wherever a vast amount of information needs to be displayed in a simple way.

Many parts of our invention are applicable to clothing stores, grocery stores, other stores, malls, museums, and libraries—in fact to any collection of information that needs to be presented in a structured fashion.

Illustrations 1 through 21 depict embodiments of our invention. In addition, these and other embodiments are described below.

### Search

A method in accordance with one embodiment of the invention includes displaying the results of a search in categorized shelves to speed up location of requested books. If the search results in no book, the method can include creating a shelf of books of a category where the book would have belonged.

The current on-line bookstores list the results of a book search in a scrolling list. Illustrations 3 and 4 show representative lists from existing on-line book and clothing suppliers. As shown schematically in Illustration 2, this arrangement is a significant departure from the real store experience. One problem is that the lists can take up several pages. For example, a search for Thomas Moore on Amazon.com brought 228 books, listed on five pages with a list of 50 books each. On each page, only about seven to ten books were initially visible on the screen, with the rest having to be seen by scrolling the page. Further, the books were listed in rather random order, making the search for the required book more difficult.

One embodiment of our invention includes a method whereby the books of the search result are displayed on a bookshelf, organized into familiar categories as in a bookstore, solving at once both the problems—firstly, a large number of books can be visible on the screen, and secondly, the categorization makes it easy to locate the needed book. Further, user controlled re-categorization further simplifies the search.

When the search results in no book, we have invented a method by which the user is shown a shelf of books from categories where the book would have been found. This helps the user to locate books similar to the one he tried to search for, perhaps with a slightly different title than the one he entered.

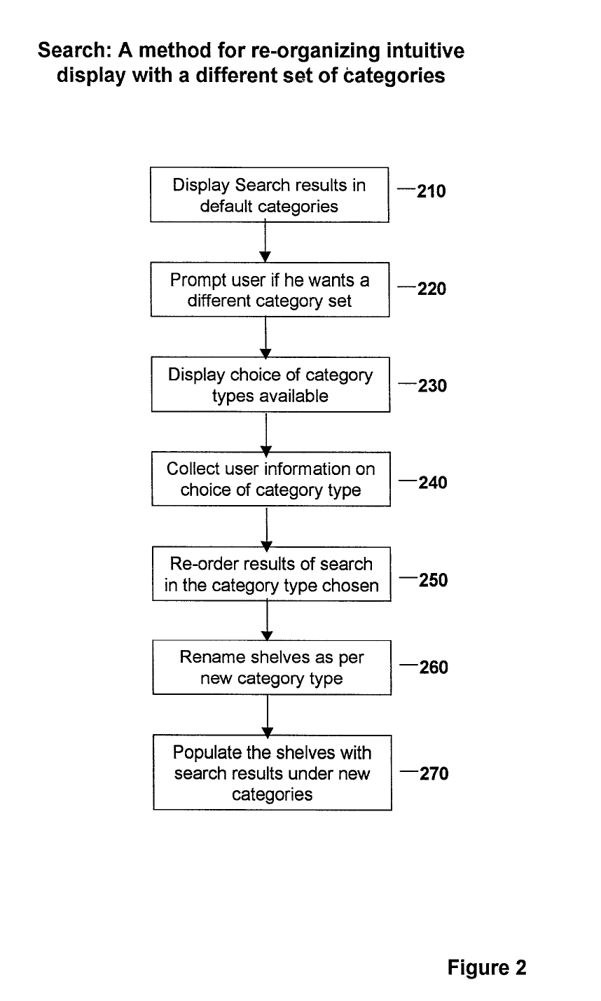

An embodiment of this method is described in flowchart FIGS. 1B and 2.

FIG. 1B describes a method for displaying the results of a book search in an intuitive way. A search screen is displayed (step 105) on which the user can enter the information that he knows about the book he is searching for. It could be the author, the title, some keywords, the ISBN number or any other information that pertains to the book. This information is collected (step 110) and is converted to a query in the appropriate format and sent to the bookstore database (step 115). If the database query results in no books, then the category or categories where the book could belong is determined (step 155) and the shelves containing these category of books are displayed to the user whereupon he can browse for books similar to the ones he was looking for (step 160). On the other hand, if one or more books that meet the criteria entered by the user are found, then the details of the books are collected from the database (step 125). These books are organized into categories based on a default category list (step 130). Depending on the number of books returned by the query, bookshelves are created in the reading room (step 135) and the books are displayed on the shelves in the order of categories (step 140). Further, the category titles are displayed on the shelves (step 145), making it easy for the user to locate books in the category he desires. All of the electronic services associated with the books, such as browsing, audio, reviews, audio reviews etc. are connected to the books in the shelves (step 150), making the newly created shelves just like any other shelf in the bookstore—all the books are available for browsing, listening to, looking at the details, buying, renting and for other services.

FIG. 2 describes a method for re-organizing (with a different set of categories) the intuitive display of the results of a book search. The search results are normally displayed according to a default category type as described in FIG. 1B. It is desirable to have the books arranged according to different category types to suit the search requirements of the user. For example, the default category list will have categories, such as literature and fiction whereas the user may want to look at books of the 60's and 50's. This could be easily achieved by having a category type based on the year of publication. Several different category types can be made available. FIG. 2 describes a method for ascertaining the desired category type and reorganizing the search results based on the desired category type, making it more intuitive and simpler for the user to view and examine the books that he is looking for.

The books from the search result are displayed in the default category type (step 210). A prompt is displayed if the user wants to see the books organized in a different category set (step 220). A menu of available category types is displayed (step 230) and the information on the choice of the desired category type is collected (step 240). The search results are re-ordered according to the new category type selected (step 250), and the shelves are renamed as per the new category type selected (step 260). The shelves are then populated with the books from the search results under the new categories (step 270).

### Audio Reviews

Another embodiment of the invention includes a method of collecting and broadcasting book reviews by the common public (visitors) in audio form.

Currently, several on-line bookstores collect written reviews by the readers. This process involves the readers and enriches their experience. However, since the reviews need to be typed, there is inertia in submitting the review. Further, those looking at the review do not get the full impact of the reader's comments.

Accordingly, in one aspect of the invention, the readers record their reviews in their own voice that is then made available to other readers wanting to know opinions on the book.

One embodiment of the invention includes making available a recording software to a user at the time he/she is reading or browsing a book, that will allow them to record their review, edit it to their satisfaction, and submit the review. Then the review is placed in a database and in the e-package of the book to be made available to future browsers of that book.

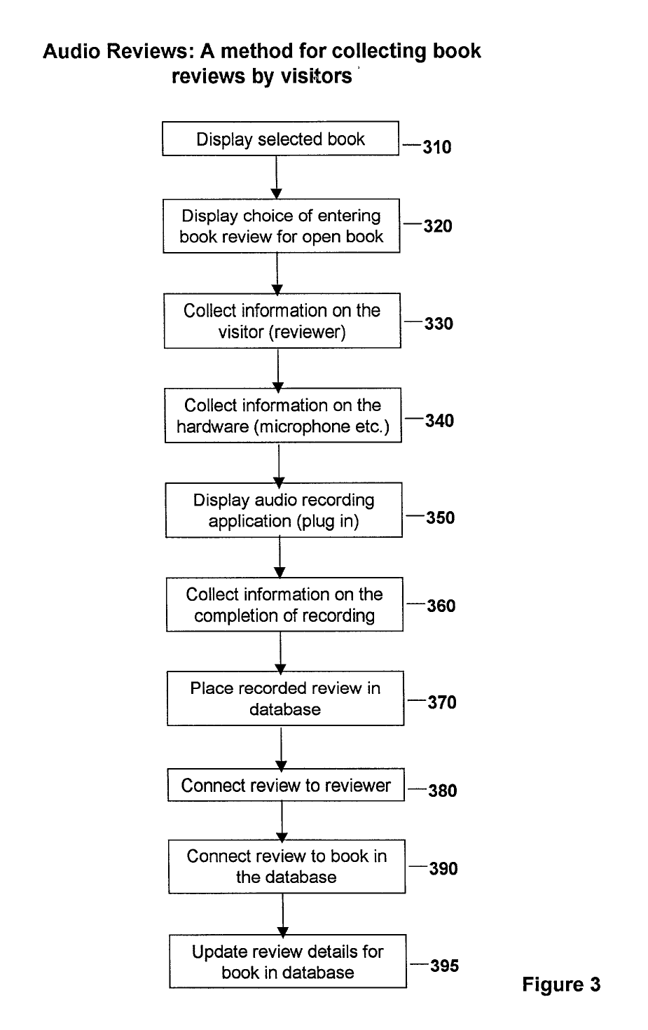

Another embodiment of the invention includes a method that also allows a user to listen to other reviews of a particular reviewer that he fancies. Aspects of this embodiment are described in flowchart FIGS. 3, 4 and 5.

FIG. 3 describes an embodiment of the invention that includes a method for collecting book reviews by visitors to the on-line bookstore. The selected book is displayed (step 310) and the possibility of entering an audio review of the book is displayed (step 320). Information on the visitor (reviewer) is collected (step 330) and saved in the database if necessary. Information on the hardware available to the reviewer such as microphone etc. is collected (step 340) to ensure that it is appropriate for the recording of the review. The audio recording plug in is then displayed to the user (step 350) with which the user will be able to record the review. Information is collected on the completion of the recording of the review (step 360) at which point the recorded review is stored in the database (step 370). The review is connected to the reviewer in the database (step 380) and to the book in the database (step 390). The list of reviews available for the book and other review details for the book are updated (step 395).

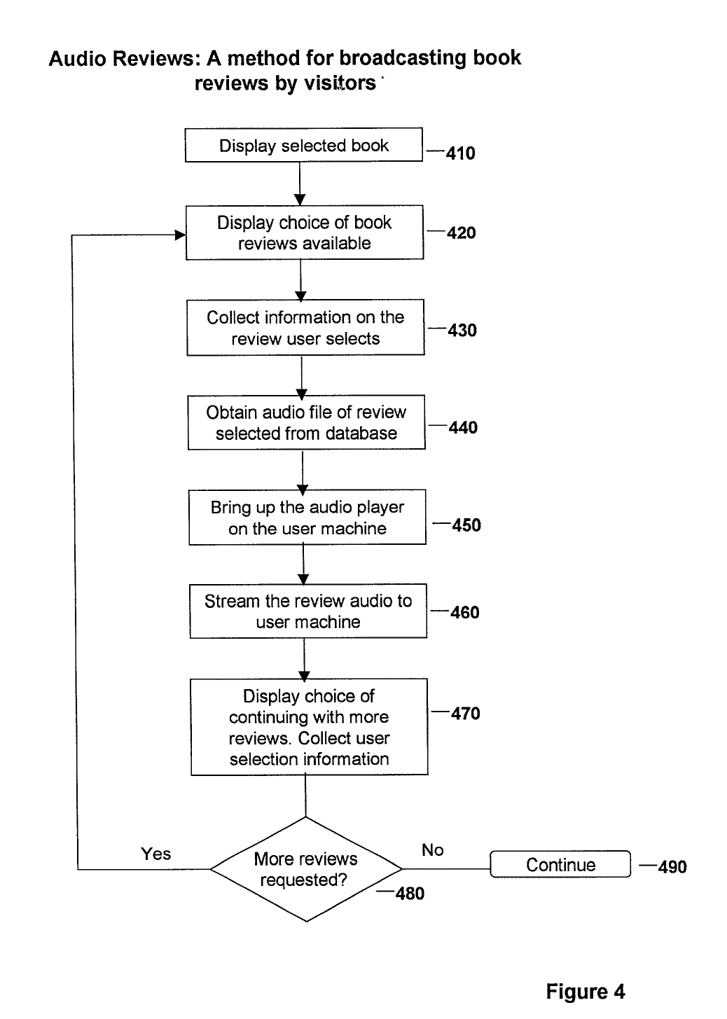

FIG. 4 describes an embodiment of the invention that includes a method for broadcasting book reviews by visitors on demand. The selected book is displayed (step 410) and a choice of available book reviews is displayed (step 420). Information on which review the user selects is collected (step 430) and the audio file of the selected review is retrieved from the database (step 440). The audio player on the user machine is brought up (step 450) and the audio of the selected review is streamed or otherwise transmitted to the user machine (step 460). When review playing is completed, the option of listening to more reviews is displayed to the user and information on the user selection is collected (step 470). If a user requests more reviews (step 480) a menu of available reviews is shown (step 420), and the process is repeated. Otherwise, the process continues with the next user request (step 490).

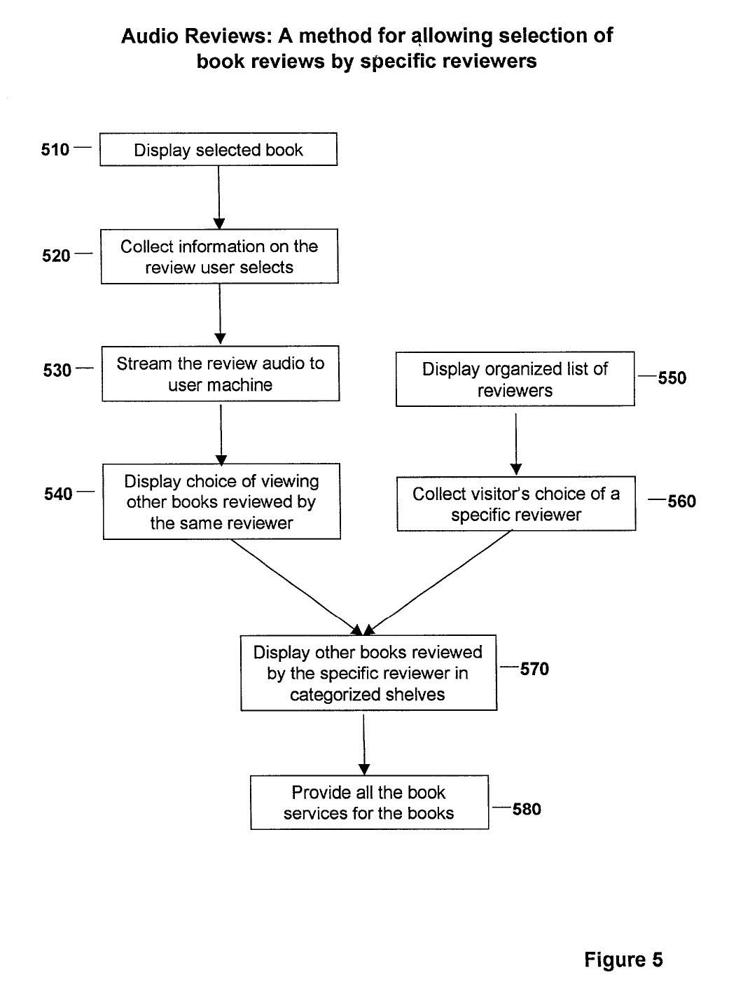

FIG. 5 describes an embodiment of the invention that includes a method for allowing selection of book reviews by specific reviewers. The selected book is displayed (step 510) and a choice of available book reviews is displayed as in FIG. 4. The information on the user's selection of a desired review is collected (step 520) and the audio of the selected review is streamed or otherwise transmitted to the user machine (step 530). The portion of viewing other books reviewed by the same reviewer is displayed (step 540) which, if selected, moves the process on to step 570. Alternately, a list of reviewers organized in various ways (geographic, male/female, types of books reviewed etc.) is displayed (step 550) and the visitor's choice of the specific reviewer is collected (step 560). Then the books reviewed by the specific reviewer are brought in from the database and displayed in categorized shelves (similar to displaying the results of a book search) (step 570). All the services associated with the books are linked to these books in the shelves (step 580), whereupon the user can browse any of these books and listen to the reviews by the selected reviewer or by other reviewers that he may choose.

### Public Book Voicing

Another embodiment of the invention includes a method of encouraging the common public to voice complete books, a method for enabling such voicing to be recorded and collected in a database, and a method to make the recording available for on-line visitors.

While very popular books can be profitably voiced, it is expensive to voice many books. By encouraging the common public to voice books of their choice, the number of voiced books increases dramatically.

In one embodiment, the method includes making available to the user recording software with which the user can voice a selected book, edit it and submit it. An automatic software recognizes and classifies the voice pattern of the reader and gives it a rating. Readers having a high rating can be approached to provide additional recordings.

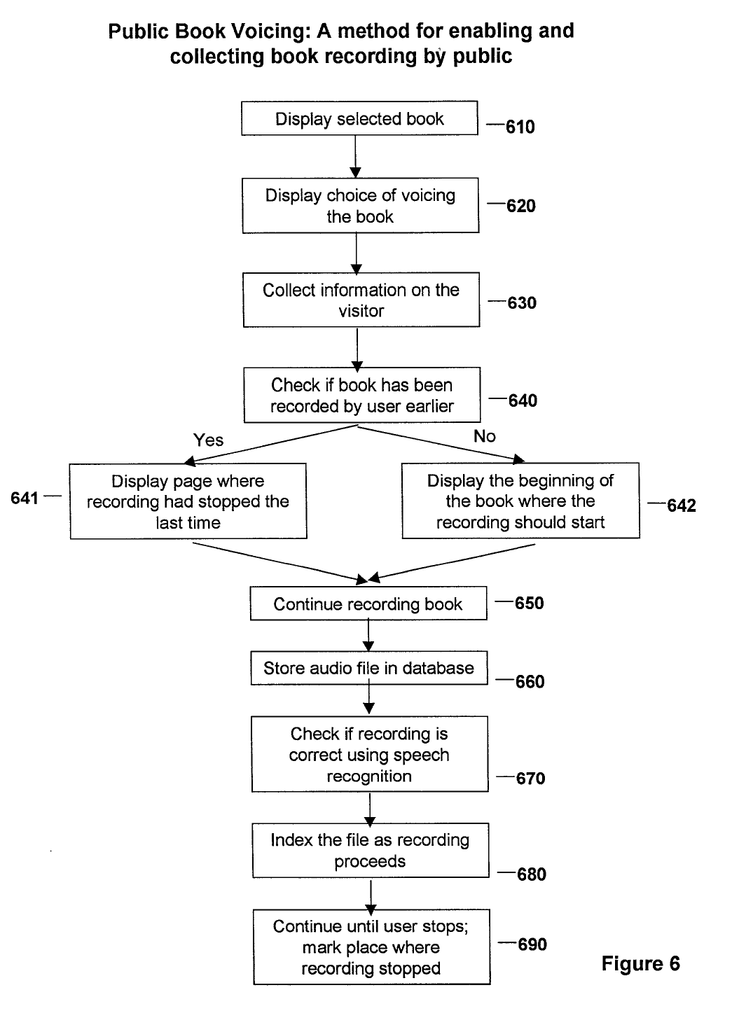

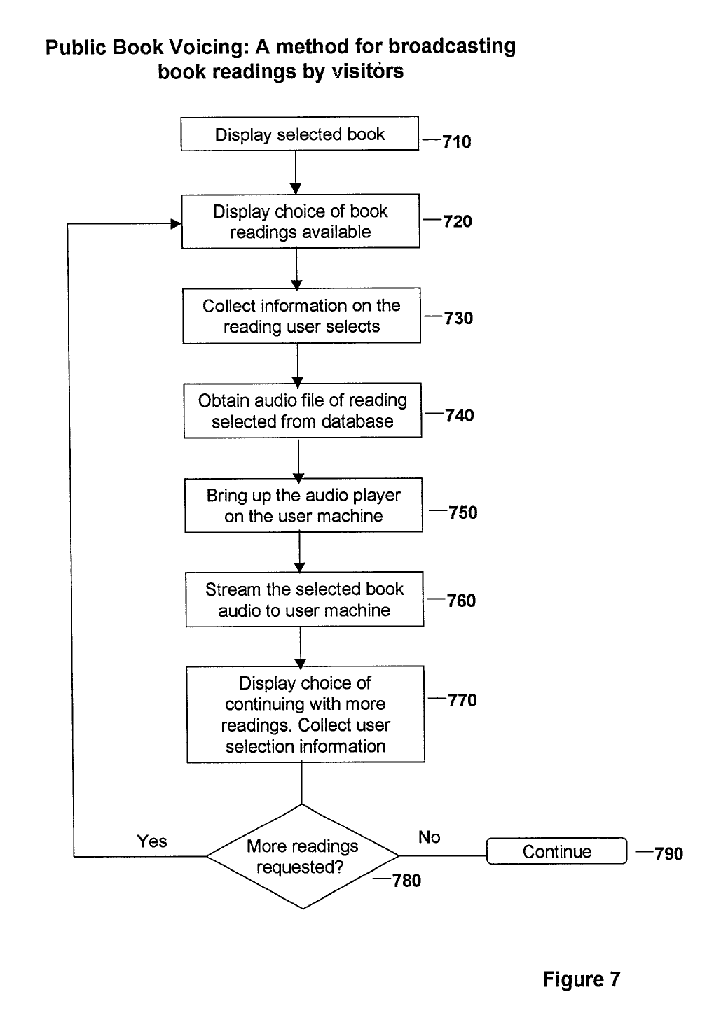

When the user selects a book for voicing, it shows him if any one else has voiced the book, and a description and classification of voicing. Based on this information, the user can decide to voice the same book or go on to a different one. The voiced book is placed in the database and attached to the e-package of the book. Aspects of this embodiment are described in flowchart FIGS. 6 and 7.

FIG. 6 describes an embodiment of the invention that includes a method for enabling and collecting book recordings by public. First the selected book is displayed (step 610) and the possibility of voicing the book is displayed (step 620). The information on the visitor is collected (step 630) and stored in the database if necessary. Then the database is checked to determine whether the particular visitor has recorded the book earlier (step 640). If yes, the page where the recording had stopped during the previous recording session is displayed (step 641). Otherwise, the beginning of the book is displayed (step 642) where the book recording can start. The recording of the book is continued (step 650). As the recording proceeds, the audio file is stored in the database (660) and the reliability of the recording is checked using speech recognition by comparing the spoken word with the printed word in the book (step 670). The audio file is indexed to correspond to the printed book as the recording proceeds (step 680). The process continues until the user stops, at which point the place where the recording stopped is noted in the database (step 690).

FIG. 7 describes an embodiment of the invention that includes a method for broadcasting book readings by visitors. The selected book is displayed (step 710) and a choice of available book readings is displayed (step 720). Information on which reading the user selects is collected (step 730) and the audio file of the selected reading is retrieved from the database (step 740). The audio player on the user machine is brought up (step 750) and the audio of the selected book reading is streamed or otherwise transmitted to the user machine (step 760). When book playing is completed (generally similar to normal book reading with all the relevant features), the possibility of listening to more readings is displayed to the user and information on the user selection is collected (step 770). If the user requests more readings (step 780) a menu of available readings is shown (step 720), and the process is repeated. Otherwise, the process continues with the next user request (step 790).

### Advertisements for Subsidizing Books, for Audio or Browsing

Another embodiment of the invention includes a method to make browsing, reading or listening to the books more accessible by subsidizing their cost with advertising.

Normally books have been sold as an end product—not as content. One embodiment of the invention includes making the pages of books available for browsing or on-line listening, converting the books into content, and immediately making it possible to use advertising to make the content free or subsidized, just like TV or other content.

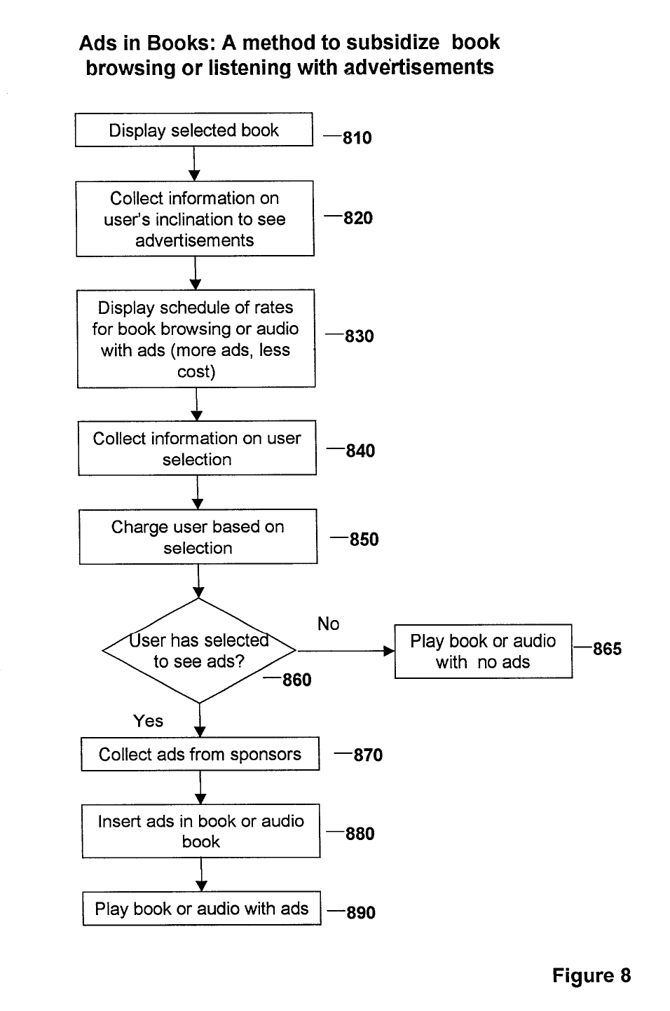

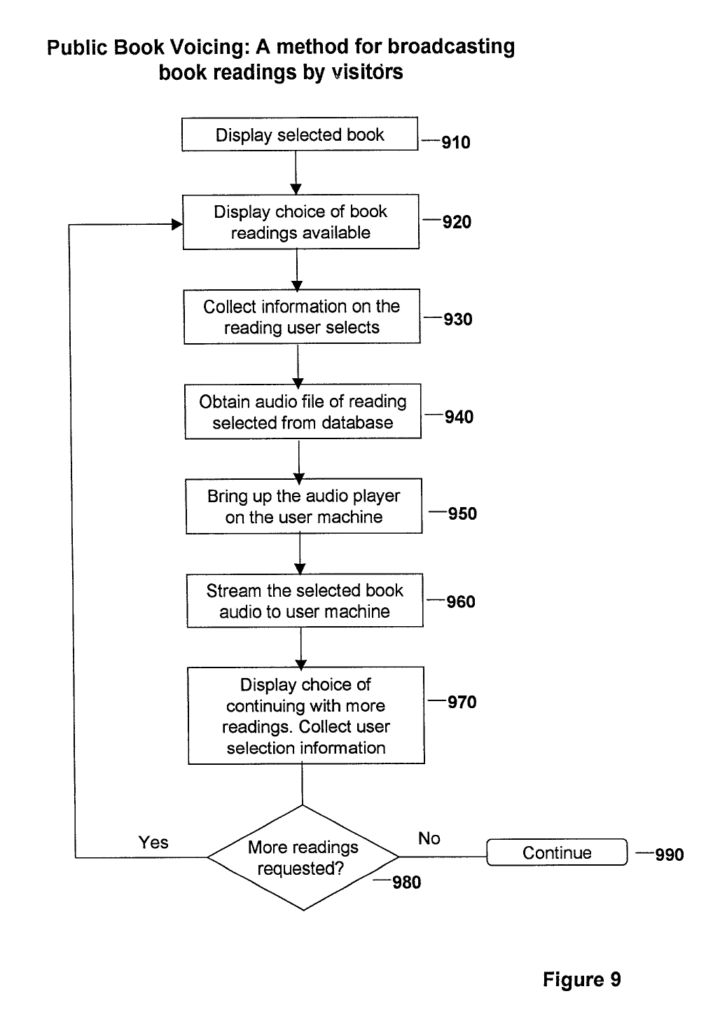

FIG. 8 describes an embodiment of the invention that includes a method to subsidize book browsing or listening with advertisements. The selected book is displayed (step 810) and information on the user's inclination to see advertisements is collected (step 820). A schedule of rates for book browsing or audio with ads is displayed (step 830). Typically the rates start high for no ads, and gradually go down if the user accepts more and more ads, until at some level of ads, the browsing or audio will be completely free. The information on user selection of the level of ads is collected (step 840). The charge for the user will be based on his selection (step 850). It the user has not selected to see ads (step 860) the book or audio is played without any ads (step 865). Otherwise, ads are collected from the sponsors (step 870) and inserted in the book browsing or audio (step 880). The book or audio is played with the inserted ads on the user machine (step 890).

### Voice Introduction to Books Pop Ups

Another embodiment of the invention includes a method to enhance the user experience and merchandising of books by adding voice/video introductions to visual pop ups (e.g., textual synopses or extracts from books or other media).

Current on-line bookstores only have passive information about books with the result that pop ups have minimal merchandizing content. One embodiment of our invention includes pop ups with rich merchandising content, especially voice introductions to the book either on audio or on video.

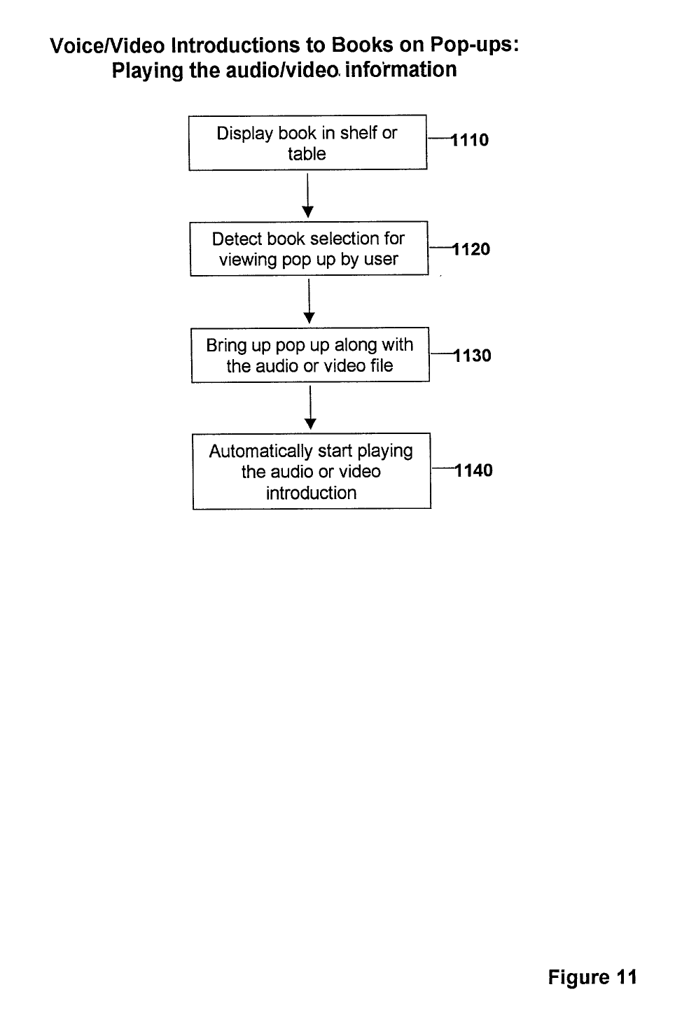

Flowchart FIGS. 10 and 11 describe aspects of an embodiment by which a book dealer or other entity can add voice introductions to the pop ups which can then be played when the pop ups are brought up by the user. FIG. 10 describes an embodiment of the invention that includes a method of storing audio/video introductions for book pop ups. The book for which the audio/video introduction is desired is selected (step 1010). Using the appropriate tools the audio/video introduction is created (step 1020). This introduction is converted to the appropriate format and stored in the bookstore database (step 1030). This audio/video in the database is connected to the book in the database (step 1040).

FIG. 11 describes an embodiment of the invention that includes a method of playing the audio/video introductions for book pop ups. The book is displayed in a shelf or table or other appropriate manner (step 1110). When a user has selected the book for viewing the pop up, it is detected (step 1120). The pop up along with the audio or video file are then brought up (step 1130), and the audio or video introduction automatically begins playing (step 1140).

### Hidden Special Offer Books

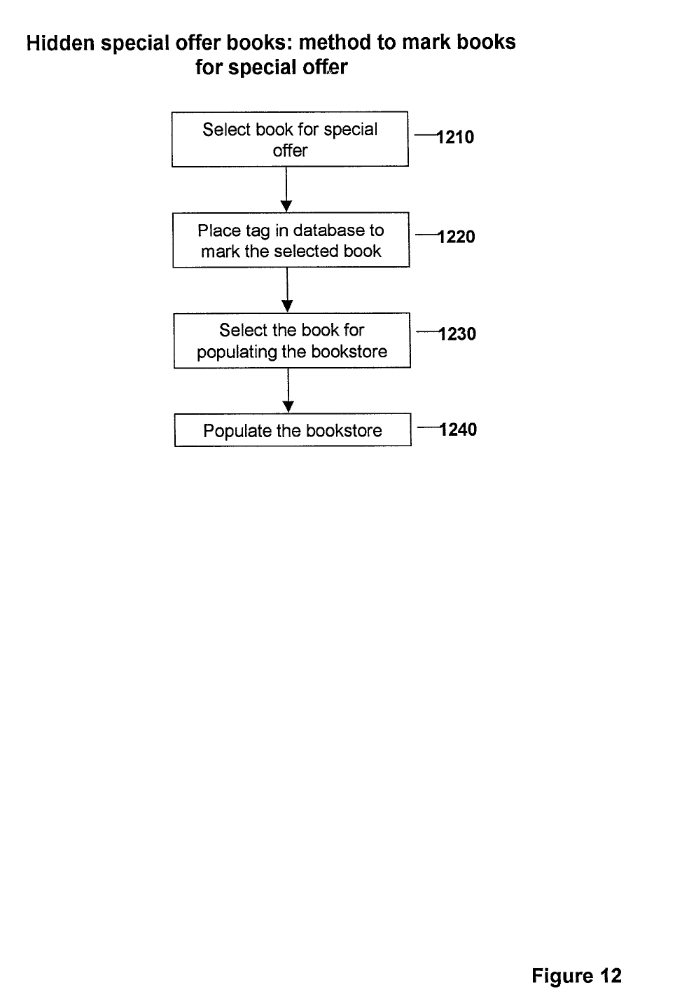

Another embodiment of the invention includes a method for marking specific books in a bookstore for special offer when discovered (picked up) by an on-line visitor, a method for marking specific books for special offer based on user preferences, and a method for displaying and offering the special offers when the books are discovered (picked up). This is described in flowcharts on FIGS. 12, 13 and 14. One of the methods of attracting visitors to the on-line bookstore and keeping them there longer is to have special offers on books hidden somewhere in the bookstore. When a visitor chances upon the book, he is immediately shown that the book is on special offer. For example, the book could be free, or could cost only a dollar, or could be 50% off. There could also be a time limit. For example the book could be 50% off if purchased in the next ten minutes. The books that go on special can be selected based on general interest. Alternately, if a user enters his profile, books on special can be selected to meet the interests of the user. This can really induce the user to explore the bookstore because he now has a higher chance of getting books of his liking and interest for free or at a discount. The specials can change periodically, and sometimes the specials can be announced and made available to everyone that is on-line during a specific length of time.

FIG. 12 describes an embodiment of the invention that includes a method to place books marked for special offer in the bookstore. The books for special offer are selected (step 1210). A tag is placed in the database to mark the selected books (step 1220). The books marked for special offer are selected to populate the bookstore (step 1230). The bookstore is then populated with the selected books (step 1240). This process will place the books marked for special offer in their proper category.

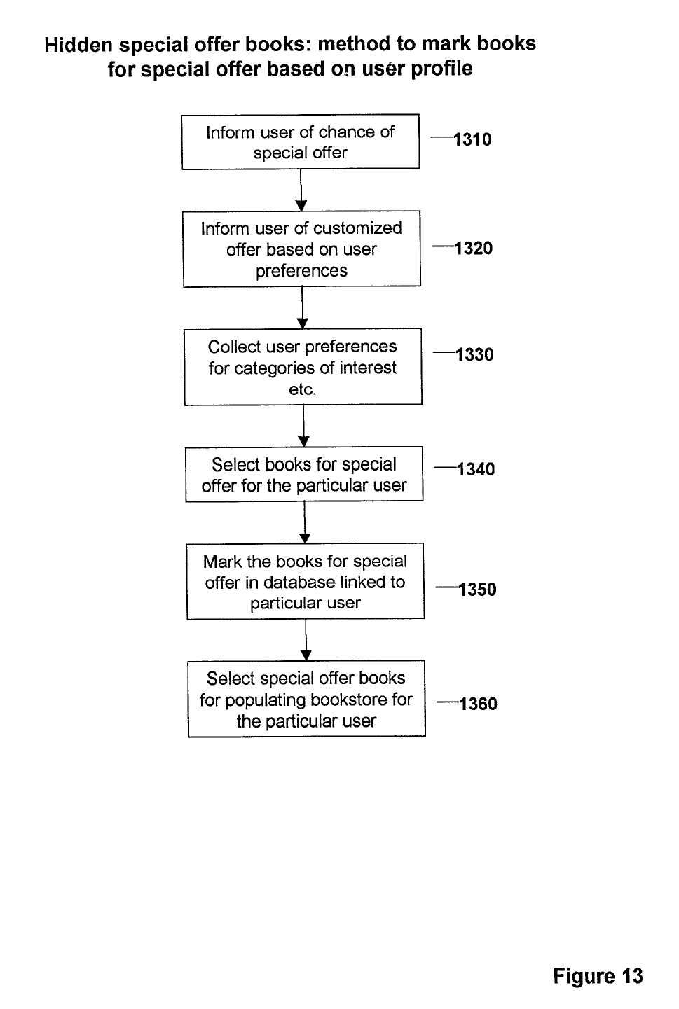

FIG. 13 describes an embodiment of the invention that includes a method to mark books for special offer based on user profile. The first step is to inform the user of the chance for a special offer (step 1310). The normal case would be to have special offer books of a general category hidden among the many books in the bookstore. To make the feature more attractive, books that are of interest to the user can be placed on special offer and still be hidden in the on-line bookstore. In step 1320, the user is informed of a customized offer based on user preferences (step 1320). The user's preferences and categories of interest are collected (step 1330). Books are then selected for a special offer that satisfies the user's categories of interest (step 1340). This selection could be different for each user. Those books targeted for special offer are marked in the database, and linked for the particular user (step 1350). In step 1360, the on-line bookstore is populated with the books marked for special offer. This process will place the books marked for special offer in their proper category for each user.

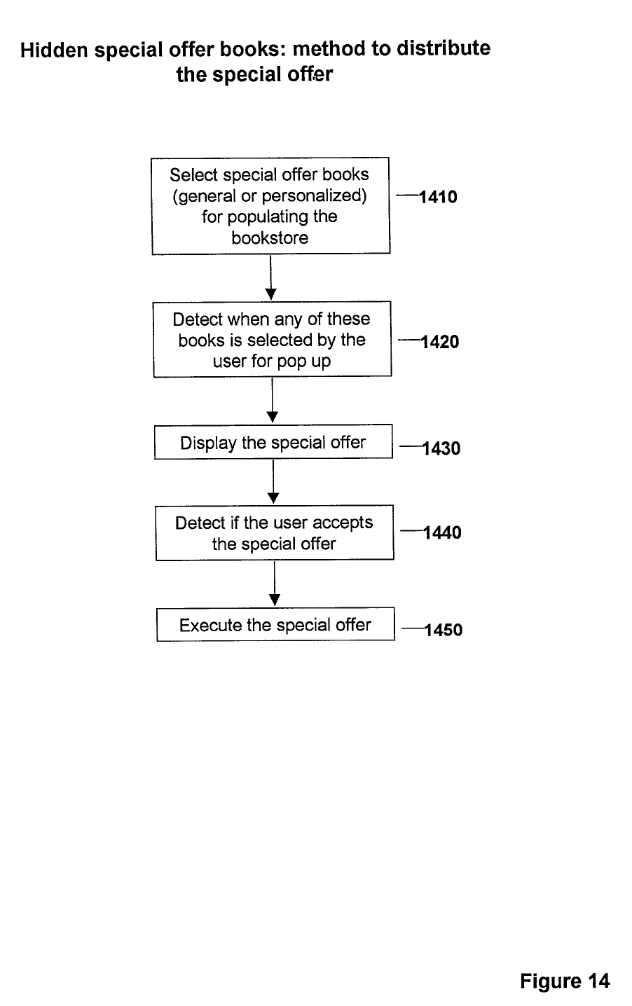

FIG. 14 describes an embodiment of the invention that includes a method to offer the special offer. The books marked for special offer (general or personalized) are placed in the bookstore under their appropriate categories (step 1410). The method includes detecting when any of these books is selected by the user for viewing the details (e.g., viewing a pop up) in step 1420. The special offer details are retrieved from the database and displayed to the user (step 1430). The method further includes detecting whether the user accepts the special offer (step 1440) and if so, executing the special offer (step 1450). This could be a huge discount on the books, free shipping, or free gift-wrapping or other special offers. They could also have a time limit. For example the special offer may be good only if the user buys the book in the following ten minutes.

### Efficient Data Storage and Retrieval

Another embodiment of the invention includes a method for storing and retrieving associated services with books

We have invented several services associated with each book that allow the visitor to experience and enjoy his/her visit to the bookstore. These are services such as giving user the ability to browse a book and thumb through it page by page, playing the audio of the book to the reader over the Internet, allowing the user to listen to reviews of the book recorded by other readers, allowing the user to record reviews of the book he is reading, interactive recipes, interactive sheet music, augmented audio, audio or video available for merchandizing, or a pop-up enriched with merchandizing audio or video. These interactive data about the book are stored in the database, all linked to the book record. When a user retrieves a book through a search mechanism or picks up a book from a shelf or a display in our on-line bookstore, the book comes with a dynamic packaging that allows the user to access all the services associated with the book. Further, the database can collect information from the user and augment itself. For example, a user may enter an audio review of the book he is viewing, and that can immediately become part of the database, and will be accessible to users that view that book in the future. At the same time, the dynamic database has the ability for different views of the data as is normally available in other databases.

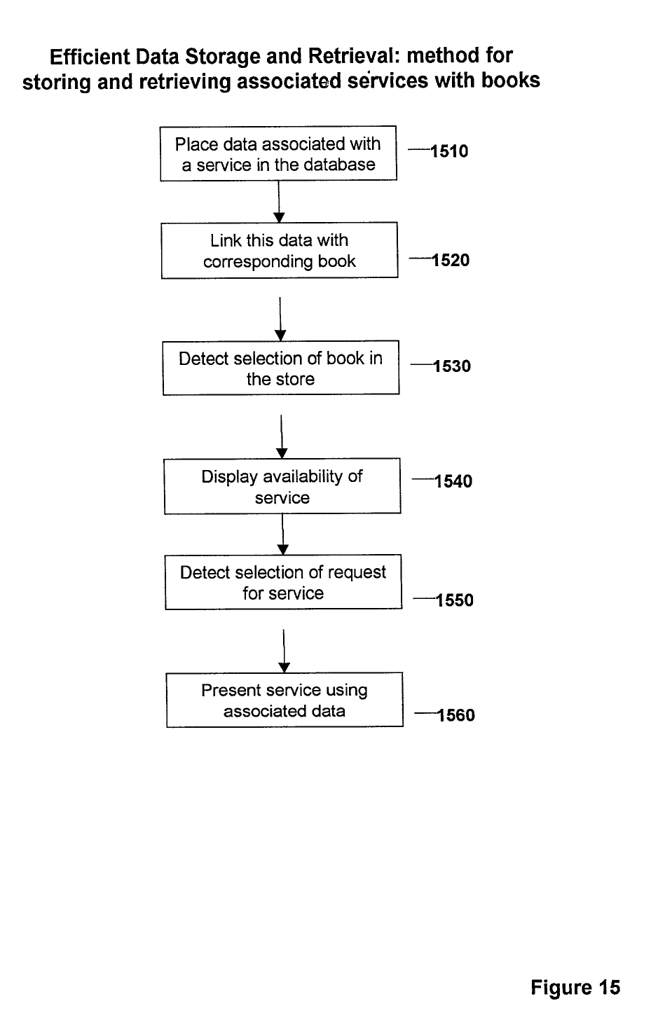

The flow diagram of FIG. 15 describes an embodiment of this process. In step 1510, data associated with one or more services is placed in a database. The services can include those described above, such as audio renditions of the book, reviews of the book, or video associated with the book, and/or other services. The services available for a particular book can be updated as the services, change. In step 1520, the service data is linked with a corresponding book. The process includes detecting the selection of a particular book by the user (step 1530) and displaying the availability of the services corresponding to that book to the user (step 1540), for example, on a computer display screen. The user then requests one or more of the services and the user's selection is detected in step 1550. The selected service is the presented to the user in step 1560 using the data associated with the service is step 1510.

### Book Pages Display

Another embodiment of the invention includes a method for displaying book pages realistically over the Internet.

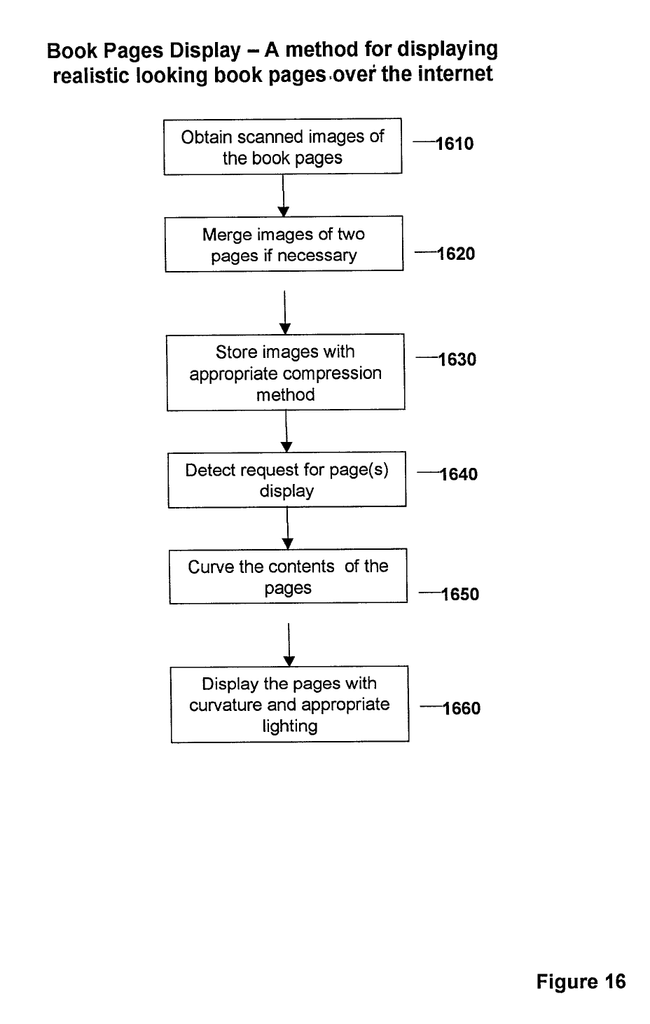

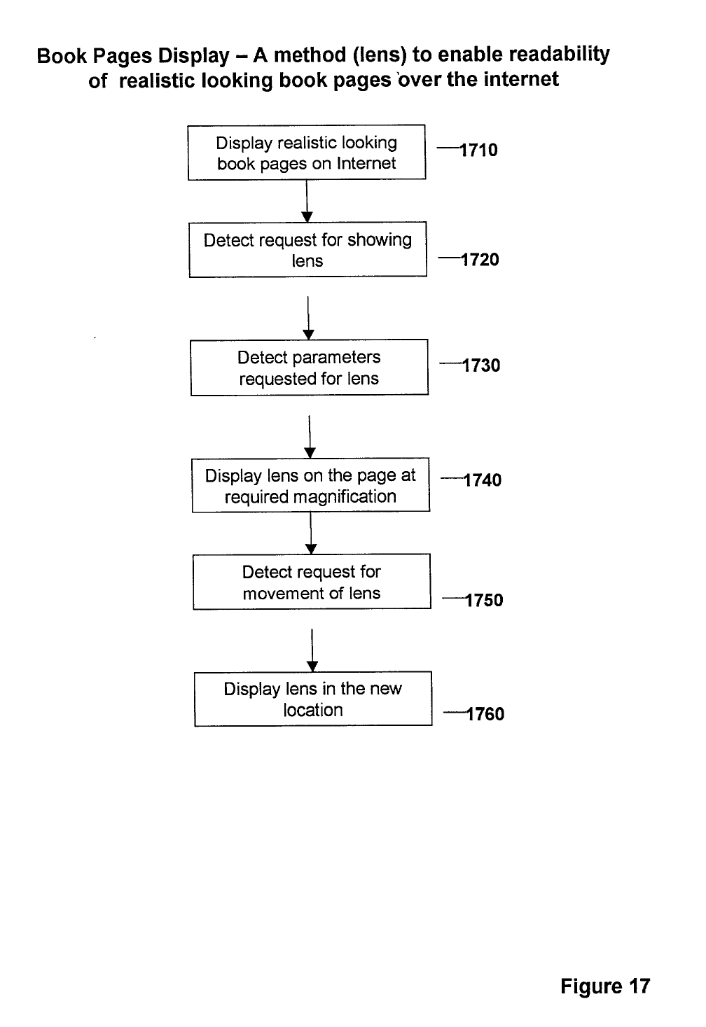

Today on the Internet, pages of a book are very rarely seen. Even when they are, it is usually not representative of a printed copy of the book. Here we have invented a method to display pages of a book and a method for making the display as close as possible to the real world view of the book. This can include having the whole page (or two pages) displayed on the screen and introducing a curvature in the text on the screen to simulate the way it is while a real book is being viewed. The curvature can be introduced either on the server side or on the client side. In this context, we enable readability without needing to change the book-like display by means of a new invention—a lens. FIGS. 16 and 17 describe embodiments of these processes.

Referring first to FIG. 16, one method includes obtaining scanned images of the book pages (step 1610). If necessary, the images of two pages are merged (step 1620). The page images are then stored with the appropriate compression method (step 1630). When a user requests a display of pages, the request is detected (step 1640) and the contents of the pages are curved (step 1650). The pages are then displayed with the appropriate curvature and lighting (step 1660).

Referring to FIG. 17, in one embodiment, book pages are displayed realistically (e.g., with curvature and lighting) over the Internet (step 1710). A request for a lens is detected (step 1720), as is a request for a parameters associated with the lens (step 1730). Such parameters can include the size, location, and magnification of the lens. In step 1740, the lens is displayed on the page at the required magnification, and in step 1750, a request for movement of the lens is detected. The lens is moved and displayed in the new location in step 1760.

### Book Audio

Another embodiment of the invention includes a method for playing the audio of a book along with the display of the book pages.

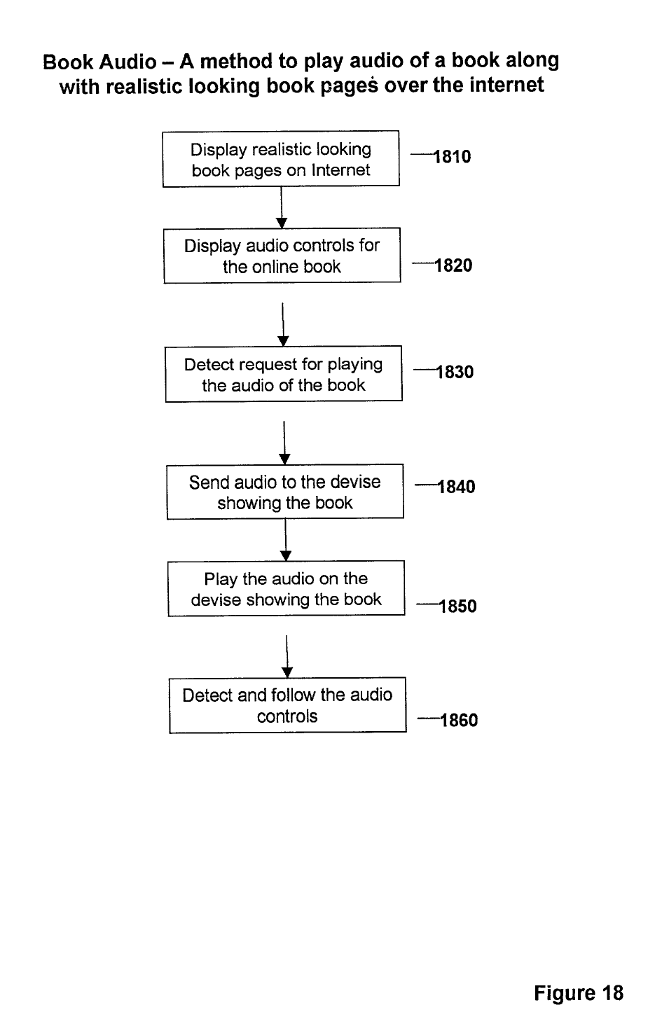

Audio books have been very popular, but usually they are played on a tape or a CD without the context of the actual book. We have invented a process whereby a user can listen to the audio of the pages of the book even as he is viewing the same pages on the screen. FIG. 18 describes aspects of this embodiment and Illustration 19 depicts the process graphically.

Referring now to FIG. 18, in one embodiment, the method includes displaying realistic looking (e.g., curved and lighted) book pages on the Internet (step 1810). Audio controls for the on-line book are displayed to the user (step 1820) and the user requests playing an audio rendition of the book, which is detected in step 1830. In step 1840, an audio signal corresponding to an audio rendition of the book is sent to the device that displays the text of the book. The audio rendition is played on the device (step 1850) and controls for the audio rendition (such as volume, fast forward requests or rewind requests) are detected and followed (step 1860).

### Use of Special Compression

Another embodiment of the invention includes a method to for using specialized compression techniques to quickly and accurately display books over the Internet.

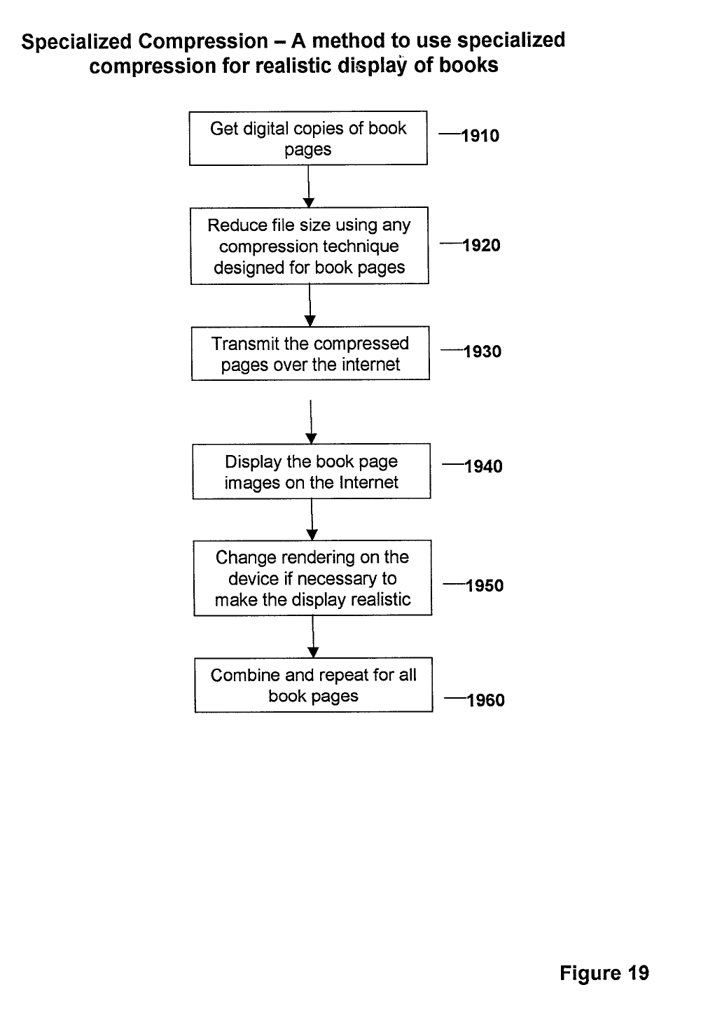

Generic compression techniques do not take account of the special characteristics of printed pages. There are special compression techniques, such as DjVu, that take account of this and they achieve significant improvements over generic compression techniques for this case. Several such compression techniques are available, but so far they have not been used in the context of a realistic presentation of a book on the Internet. We have invented a method of using these special compression techniques to display several pages of a book or the whole book, making the book browsing achievable at lower modem speeds. In other embodiments, the method can include other special compression techniques for book covers in the context of a book database, and book pages in any context. FIG. 19 describes aspects of this embodiment.

In one embodiment, shown in FIG. 19, digital copies of the book pages are obtained (step 1910) and the file size corresponding to the digital copies is reduced using any of a number of available compression techniques designed for book pages (step 1920). The compressed pages are transmitted over the Internet (step 1930) and displayed to the user via the Internet (step 1940). The manner in which the book pages are displayed on the user's device are changed if necessary to make the display more realistic (step 1950) and the technique is then repeated for all book pages to be displayed (step 1960).

### Virtual Shelf

Another embodiment of the invention includes a method for displaying a large number of books in virtual shelves that can be quickly re-ordered in different arrangements.

One of the advantages of a virtual bookstore is that space in the virtual bookstore is unlimited. There is really no physical limit to the number of books that can be displayed there, only practical concerns such as user experience.

We have invented several ways in which the virtual bookstore can be used to display in an organized way many books on the user's screen. In one embodiment, our store itself is a virtual physical store, parts of which are mapped on to the user's screen space. Different parts of the store come into view as the viewer manipulates the controls. If he manipulates the controls to indicate a move to the right, a view of the store to the right of the current position comes into view. If he moves to the left, a view of the store to the left of the current position comes into view and so on.

We have also invented several ways in which books on a virtual shelf (having hundreds or thousands of books) can be displayed on a screen a few at a time in quick succession. Each shelf can contain books of a particular category and shelves of different categories can be stacked on top of each other. The user gets a view of two or three shelves at one time on his screen. He can easily move up or move down (scroll) to other shelves using the mouse or the keyboard. Each of the shelves in turn contains books of a particular category. Again, the user sees several books in the shelf at a time on his screen, and he can scroll to the right or left in that shelf to quickly view different books. The shelves themselves can be in multiple layers to account for the different sub categories of books.

One embodiment of our invention makes categorizations dynamic, and a change in the categorization instantly rearranges the books. For example, books on history, fiction, or science can be reorganized into 20^{th} century books, 19^{th} century book or older books. Alternatively, books can be arranged in author order or title order—something not possible in a brick and mortar bookstore.

The views of the books on the shelves are customizable. Users can have a spine view where they can see many more books on the user screen at a time, or they can have a front cover view where they can see a smaller number of books, but more detail about each book, or they can have a combination where the front view of a book in spine view can be instantly brought up by placing the cursor on a book. For example, as shown in Illustration 12, users can first view a shelf showing book spines, then view the front covers of books in a selected region, and then view the spine, front cover, and rear cover of a selected book. The user can then browse through selected books. Further, the sizes of the spine or front views can be changed to increase the number of books visible at one time on the user screen.

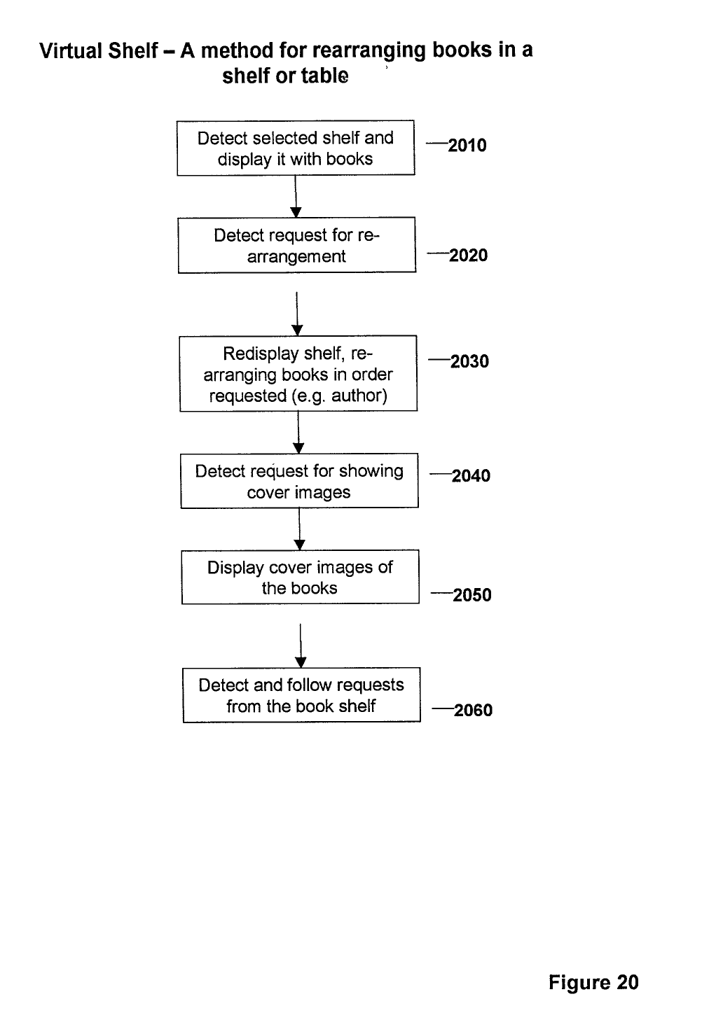

Aspects of this embodiment of a method for organizing the shelves and for re-arranging the shelves is described in FIG. 20. In step 2010, a shelf selected by the user is detected and is displayed to the user with books installed. A user request for rearrangement of the books is detected (step 2020) and the shelf is redisplayed with the books rearranged in accordance with the user's request (step 2030). A request for showing cover images of one or more books is detected (step 2040) and the cover images of the selected book or books are displayed to the user (step 2050). In step 2060, additional requests from the user relating to the books on the shelf are detected and followed.

### Personalized Store

Another embodiment of the invention includes a method for creating a store catering to specific interests of users, book selections, music preferences, and/or ambience preferences.

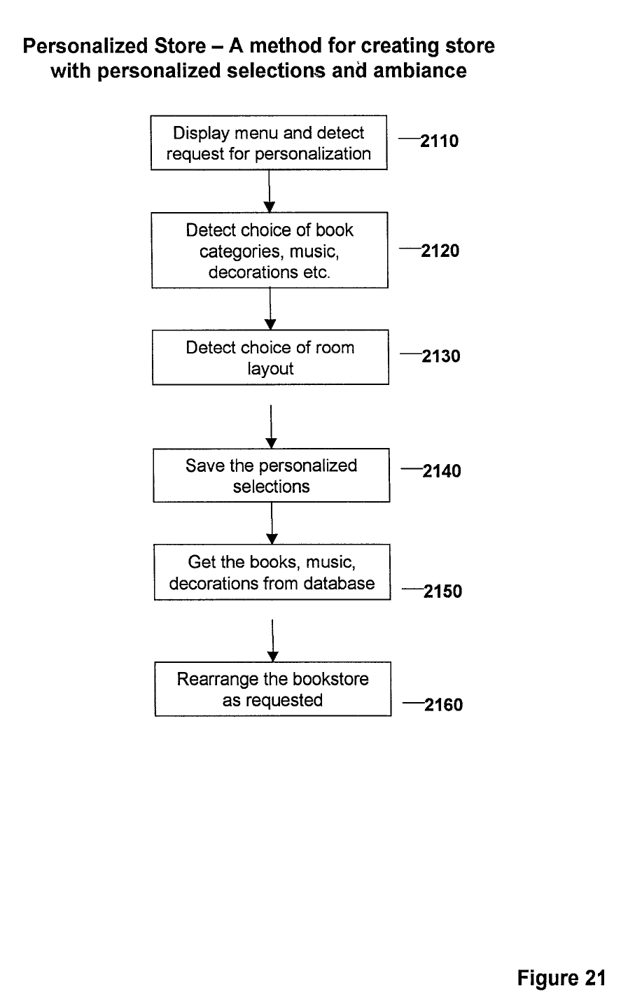

In one embodiment, our virtual bookstore includes sections (or even the whole store) configured to display the books that are of particular interest to any particular viewer. The music, the decorations etc. can all be customized to suit the tastes of an individual, facilitating a very good experience for the user. For example, if someone is interested in 19^{th} century English literature, a special room can be created with books on this topic. Many of these books may normally not be found in a general bookstore. Aspects of this embodiment are described in FIG. 21.

Referring now to FIG. 21, a menu is displayed to the user and requests for personalization of the bookstore or a portion of the bookstore are detected (step 2110). The user's choice of book categories, music preferences, preferences for decorations, and/or other preferences related to the display of the bookstore to the user are detected (step 2120). An embodiment of the method can further include detecting the user's choice of a room layout (step 2130) and saving the personalized selection, for example, for later retrieval (step 2140). The books, music, decorations and/or other aspects of the user's preferred environment are retrieved from a database (step 2150) and the bookstore is rearranged in accordance with these preferences, as requested by the user (step 2160).

### Personalized Research Room

Another embodiment of the invention includes a method for creating a room in the store specializing in research in a specific topic.

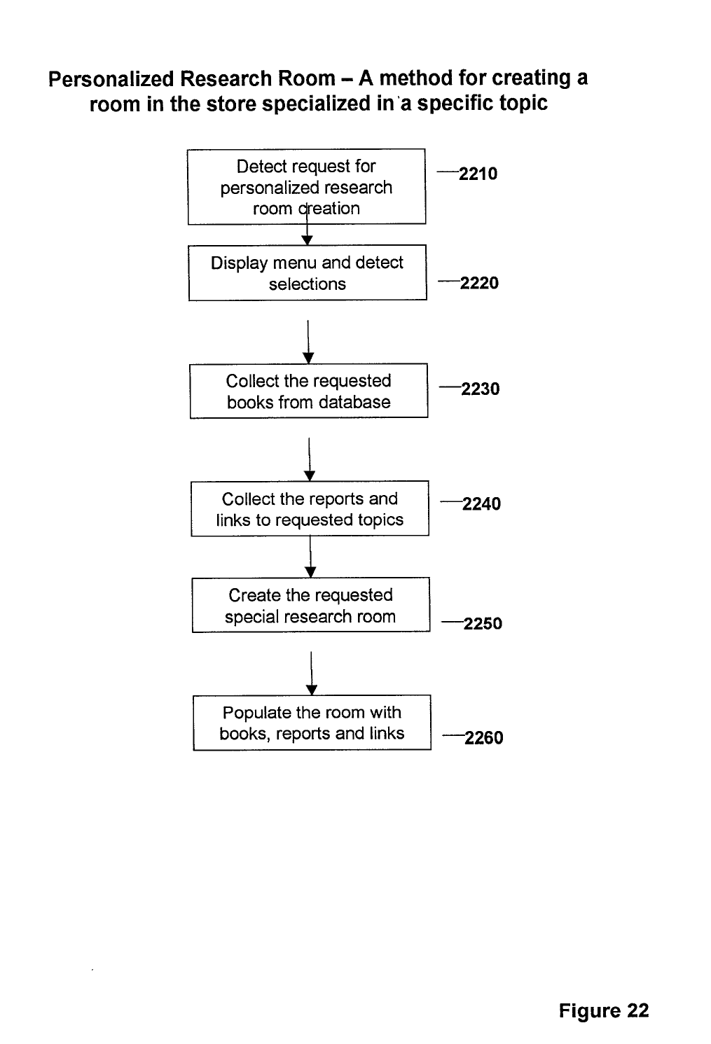

The personalized store described above can be changed to accommodate research on a specific topic. In addition to books published (in and out of print) on that topic, this room can also be searchable with a natural language query mechanism; it can also include links to other sites that could be relevant to this research topic. Aspects of this embodiment are described in FIG. 22.

Referring now to FIG. 22, the method can include detecting a request for personalized research room creation (step 2210) in one embodiment. A menu of available options is displayed and selections from the menu are detected (step 2220). In step 2230, the requested books are collected from the database, and in step 2240, reports and links to requested research topics are collected. The requested special research room is created (step 2250) and the room is populated with books, reports, links, and/or other information as requested by the user and displayed to the user (step 2260).

### Printing Single Copies of Books On-Line

Another embodiment of the invention includes a method for collecting user requests for an out-of-print or out-of-copyright book, and printing a single copy of the book.

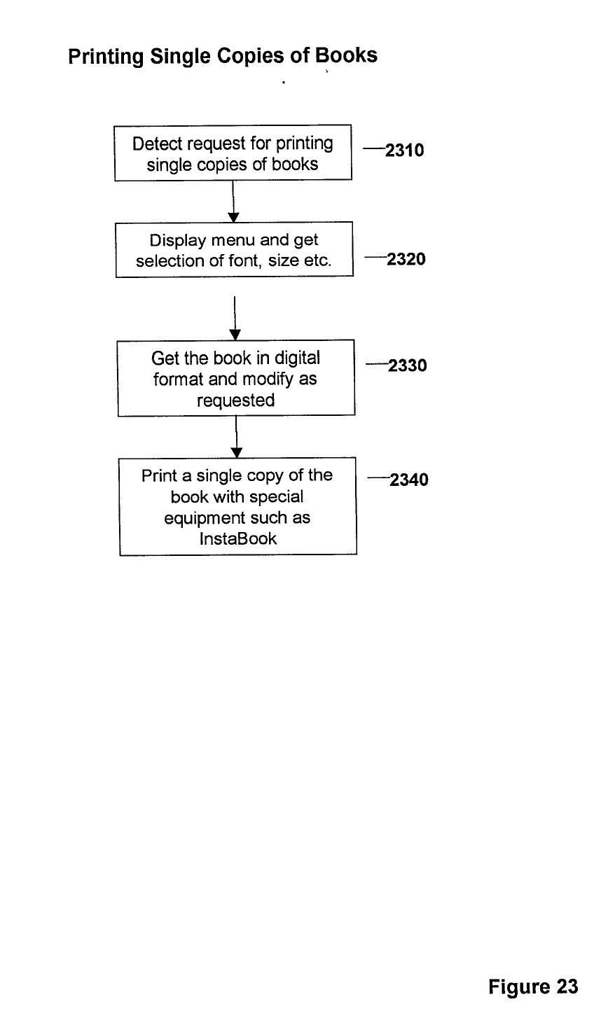

Recently, technology has made it cost effective to print single copies of books. What we have invented here is a method to use this technology to print single copies of any book whether in print, out-of-print or out-of-copyright based on user request on-line. The user can input customization information such as the font or font size he wants the book in. Aspects of this embodiment are described in FIG. 23.

In one embodiment, a request for printing single copies of books is detected (step 2310) and a menu including available fonts, page sizes and other related parameters is displayed to the user (step 2320). The user's selection of these parameters is obtained and a digital copy of the book is retrieved and formatted in accordance with the requested parameters (step 2330). A single copy of the book is printed with specialized equipment, such as InstaBook (step 2340).

### Printing Personalized Single Copies of Books

Another embodiment of the invention includes a method for collecting a user request for an out of print or out of copyright book along with personalization information from the user and printing a single copy of the book with the personalization information.

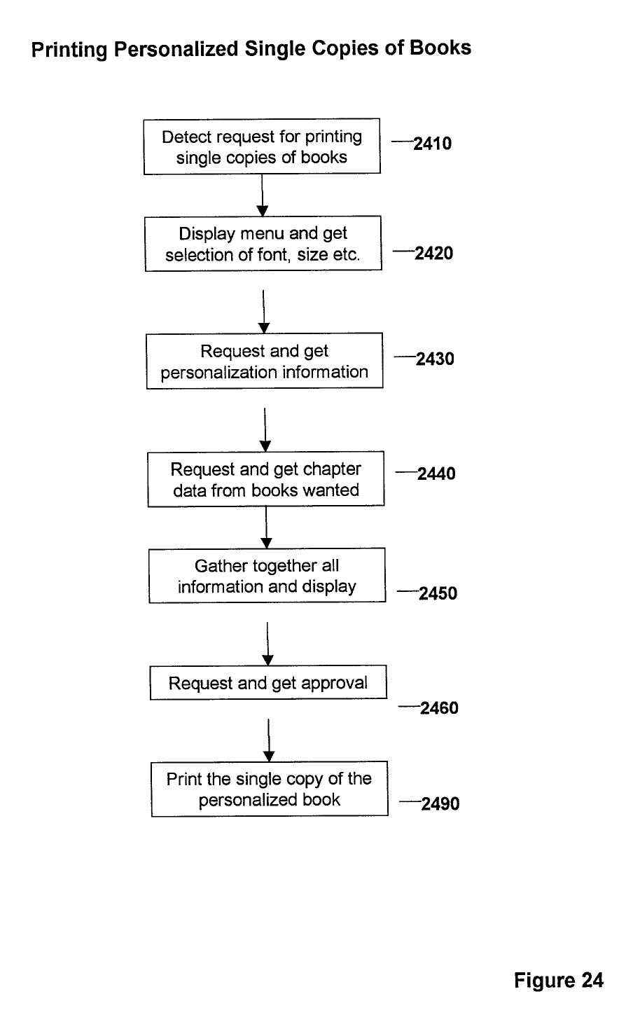

Now that it is possible to print single copies of books cost effectively, it is also possible to personalize each copy of the book—with scanned hand written matter or personal information of the user or a photograph, and of course the font and font size information. In addition, chapters from multiple books can be combined together, just as is done in specially ordered CDs. Aspects of this embodiment are described in FIG. 24.

Referring now to FIG. 24, a method in accordance with one embodiment of the invention includes detecting a request for printing single copies of books (step 2410), and displaying the menu including available font sizes, page sizes and other parameters for the user's selection (step 2420). The method further includes requesting and receiving personalization information from the user (step 2430), requesting and obtaining chapter data from selected books (step 2440) and gathering together the information for display (step 2450). Approval is requested and obtained (step 2460) and a single copy of the personalized book is printed (step 2490).

### Printing Single Copies of Books with Advertisements

Another embodiment of the invention includes a method for printing single copies of books with advertisements that can reduce the cost of the book to the user.

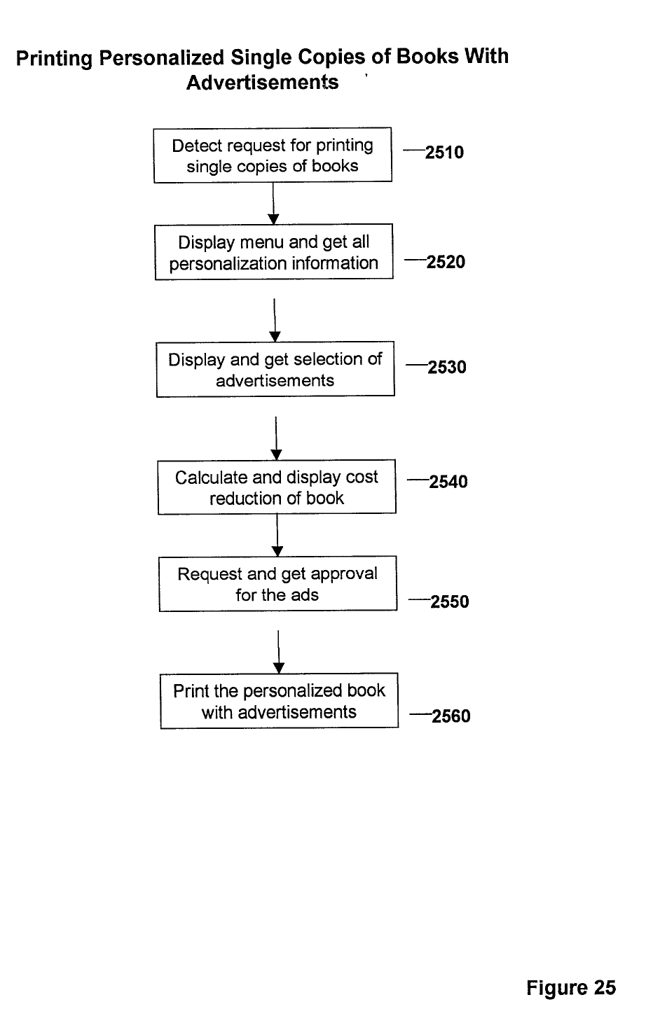

Single copies of the book can contain advertisements that the user can select to make the book cheaper to buy. The user can also select the advertisements as information (e.g., someone buying a book on start-ups may choose to have ads for lawyers and venture capital organizations). Aspects of this embodiment are described in FIG. 25.

In one aspect of this embodiment, a request for printing single copies of books is detected (step 2510) and a menu displaying personalization information is displayed (step 2520). The personalization information is obtained and a selection of advertisements is displayed to the user (step 2530). The method can further include calculating and displaying to the user the cost reduction of the book, assuming the selection of advertisements is included (step 2540), and requesting and receiving approval for the selection of advertisements to be included in the book (step 2550). The personalized book is then printed with the advertisements included (step 2560).

### Consolidated Ad Subsidy of Books or Other Aspects

Another embodiment of the invention includes a method for aggregating the subsidy of ads to multiple viewers and presenting the aggregated subsidy to one or more viewers.

Each time an on-line advertisement is viewed by a visitor to the web site, the web site gets a commission. This commission is generally very small (from few cents to a dollar), and is not significant enough to reduce the cost of a book (or other articles) to the visitor. However, if the ad revenues from the viewing of many visitors, say 1000 visitors, is consolidated, it can amount to a respectable number, say $50. This $50 can be used to give a free book of choice to one of the 1000 visitors. In one implementation, visitors to the site select one or more books they would like to have, and then select the category of advertisement they would like to see, such as computers, software, or clothing. An appropriate advertisement is shown to the visitors. After the viewing of the advertisement, the user may be given the tally of the amount of money that has collected in the subsidy until that time, and the viewer can click a button to enter a draw. Once the tally reaches a pre-set amount, one visitor's name is drawn from among those whose viewing of the ads made the tally. That viewer is offered a book from among the ones he has already selected. If the book value (plus shipping and handling) is less that the tally, say $50, the visitor is sent the book totally free of charge. Otherwise, the visitor can choose to pay the difference or opt to place the money on his account for later use. If the visitor clicks through the advertisement and visits the sponsoring site, the commission could be higher and will speed up the tally, increasing to the pre-set limit sooner. Any purchases he may make at the sponsoring site could also contribute to the tally. The viewer can choose a lower pre set tally to increase his chances of winning, or he can go for a larger pre-set tally to win more in one viewing. A visitor will be allowed to view as many ads as he wants to, each one adding to the total tally.

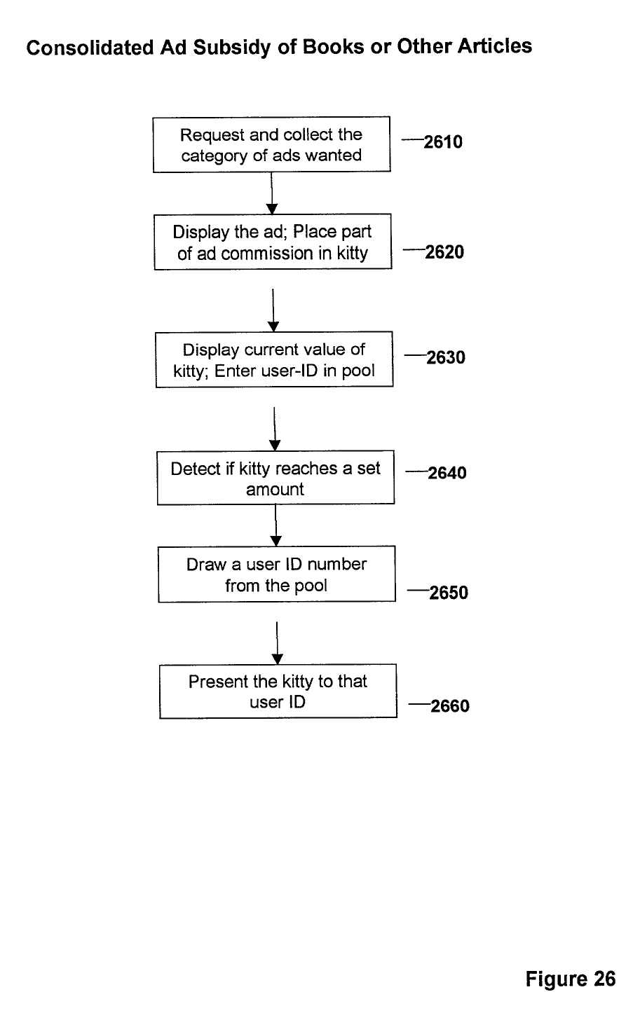

One innovative feature of this idea lies in the low amount of the pre-set total tally. Instead of a prize of $100,000 or more, the prize is set at $25, $50 or a similar value. This will greatly increase the chances of winning, say from one in 10 million to one in 1000, for example. One out of 1000 visitors would have won a book by just viewing one ad. And if they view three ads a day, one out of 10 visitors would have got a free book within a month. That creates goodwill and viral effect to make the web store known by very many people in a short span of time. Aspects of this embodiment are described in FIG. 26. In one aspect of this embodiment, the categories of ads desired by each user is requested and collected (step 2610). In step 2620, the ad is displayed and a portion of the commission resulting from the ad is placed in a kitty. The current value of the kitty can be displayed to the user and the user's ID can be entered in a pool for collecting the kitty (step 2630). When the kitty reaches a preselected amount, this event is detected (step 2640) and a user ID number is drawn (for example, at random) from the pool (step 2650). The kitty is then presented to the user corresponding to the selected user ID (step 2660).

### Consolidated Discount for Purchases

Another embodiment of the invention includes a method for consolidating discounts/awards on purchases of each item by users and presenting the aggregated discount/award to one or more viewers.

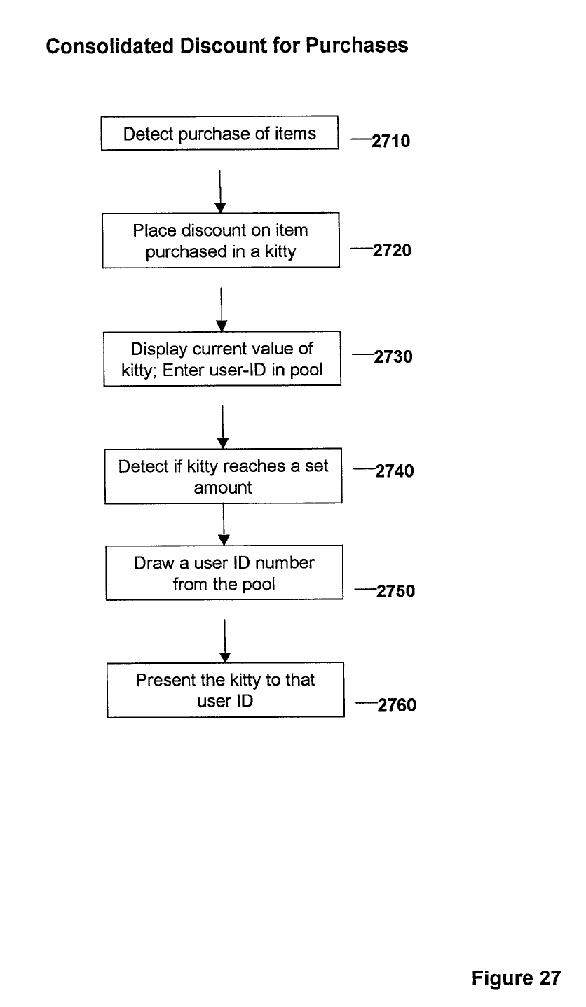

Each time an item is purchased, a small discount or award is set aside in a pool and when the pool reaches a pre-set amount, the whole pool is awarded to one or more users based on a draw among the users that contributed to the pool. Aspects of this embodiment are described in FIG. 27.

In one aspect of this embodiment shown in FIG. 27, the method includes detecting the purchase of particular items (step 2710). Any discount on the purchased item is placed in a kitty (step 2720). The current value of the kitty is then displayed to the user and the user's ID is entered in a pool (step 2730). When a kitty reaches a set amount, this event is detected (step 2740) and one of the user IDs is drawn from the pool (step 2750). The kitty is then presented to the user corresponding to the drawn user ID (step 2760).

### Affiliation with Libraries and “Small” Bookstores

Another embodiment of the invention includes a method for providing the virtual bookstore capabilities to libraries and “small” bookstores.

We have invented a business process in which the virtual reality metaphor that we have created can be rented or sold to libraries or “small” bookstores that can then provide the enhanced experience to their own customers.

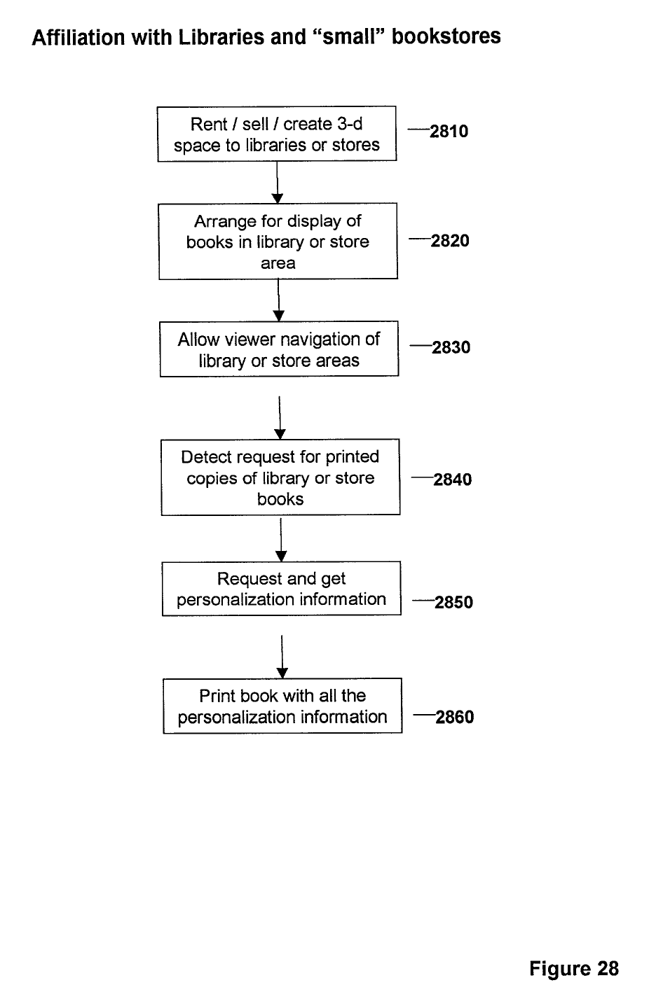

In addition, we have invented a business process in which these customers can order books they see in the libraries directly from the sponsoring store. These books can be in print or out of print. In the latter case our business process of printing single copies of books with personalization can be used. Aspects of this embodiment are described in FIG. 28. In one aspect of this embodiment, the method can include renting, selling, and/or creating or simulating three-dimensional space to libraries or stores (step 2810). The method can further include arranging for the display of books in a library or story area (step 2820) and allowing viewers to navigate through the library or store area (step 2830). Requests for printed copies of library or store books are detected (step 2840), and the method can further include requesting and obtaining personalization information from users (step 2850). The book is then printed with the personalization information (step 2860).

### Creating Specialized Book Displays

Another embodiment of the invention includes a method for creating an area of the store emphasizing a particular theme.

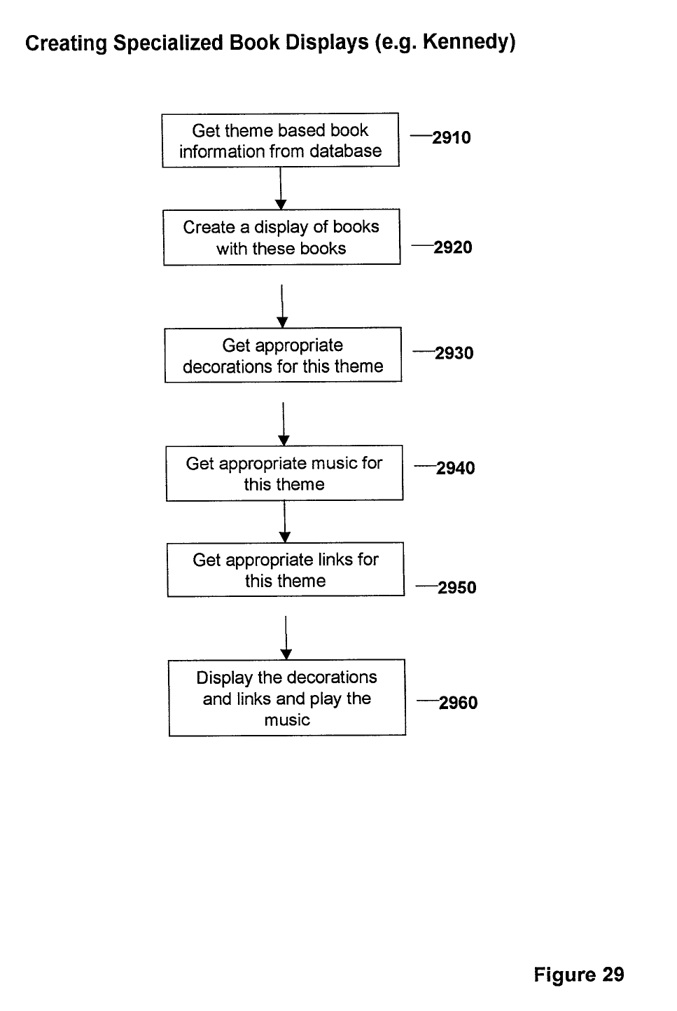

Areas of the virtual stores or whole rooms can be decorated to emphasize a special theme with appropriate books displayed therein. For instance, an area at the entrance to the store can have a display of Kennedy books; there could be another display for bargain books; a whole room can be devoted to books on Italy with wall decorations to match. These capabilities make use of the merchandizing knowledge gained in a brick and mortar context and at the same time are more powerful. For instance, it could take several days to create a Kennedy display in a brick and mortar store—the books have to be ordered from the warehouse, displayed, decorated etc. In the Internet virtual store based on our model, one can create the display in less than an hour, including some artwork and photographs. Lighting can be used to give relative emphasis for different parts of the display. Further, the displays in a brick and mortar store need to be dismantled to make place for other displays. In our store, they can be stored on a database to be instantly recalled whenever a customer wants to see it. Aspects of this embodiment are described in FIG. 29.

Referring now to FIG. 29, information pertaining to books categorized by a particular theme are obtained from the database (step 2910) and a display of the these books is created (step 2920). The method can further include retrieving appropriate decorations (step 2930), appropriate music (step 2940) and appropriate links (step 2950) for the particular theme. The decorations and links are displayed and the music played to the user to provide a consistent environment (step 2960).

### Creating Links to Other Sites from Displays in the Virtual Store

Another embodiment of the invention includes a method to provide links to other sites or other parts of the site from a display of books.

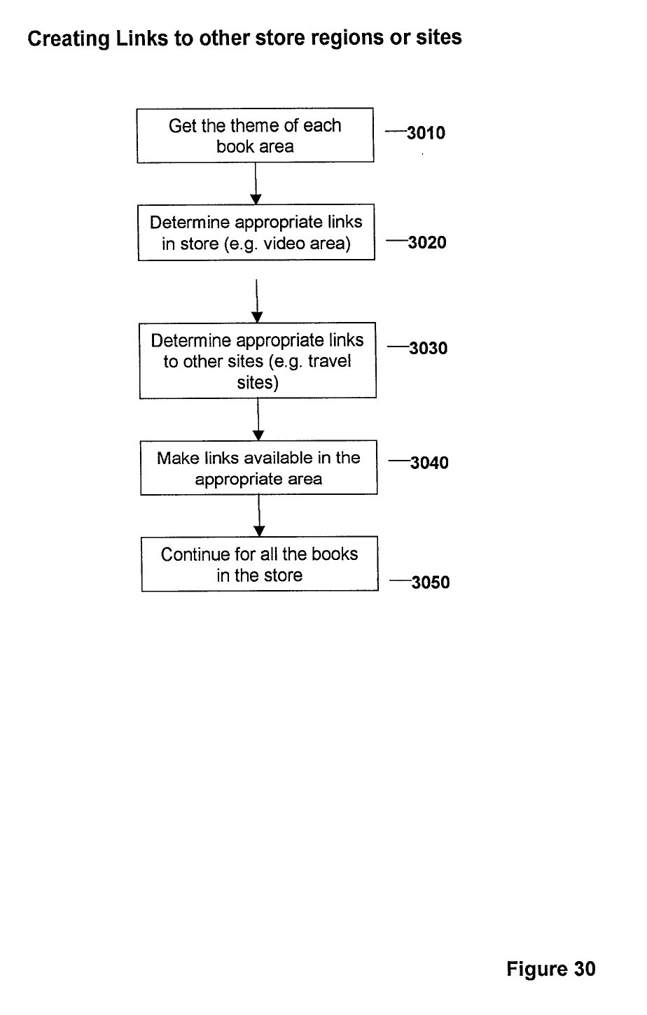

A customized display also makes it appropriate to have links to related sites or e-commerce sites. For instance, a display of books on Italy can have a link to a travel site that sells tour packages to Italy or other places, or a site that will have other Italian goods or an Italian museum. Alternatively, the display can include a link to the video section of the store (or another site) with Italian movies or tours of Italy, or a link to Italian CDs can be placed in this area. In another aspect of this embodiment, items of merchandise can be instantly brought in and displayed on the shelves and offered for sale. Aspects of this embodiment are described in FIG. 30. In one aspect of this embodiment, the theme for each book area is obtained (step 3010) and appropriate in-store links are determined (step 3020). The method can further include determining appropriate links to other sites which may be outside the store (step 3030) and making all the links available in an appropriate area of the store (step 3040). Steps 3010-3040 can be repeated for all the books in the store (step 3050).

### Creating Display of Catalogs

Another embodiment of the invention includes a method for creating a viewable version of printed catalogs on-line and providing viewers with the ability to order from the catalogs.

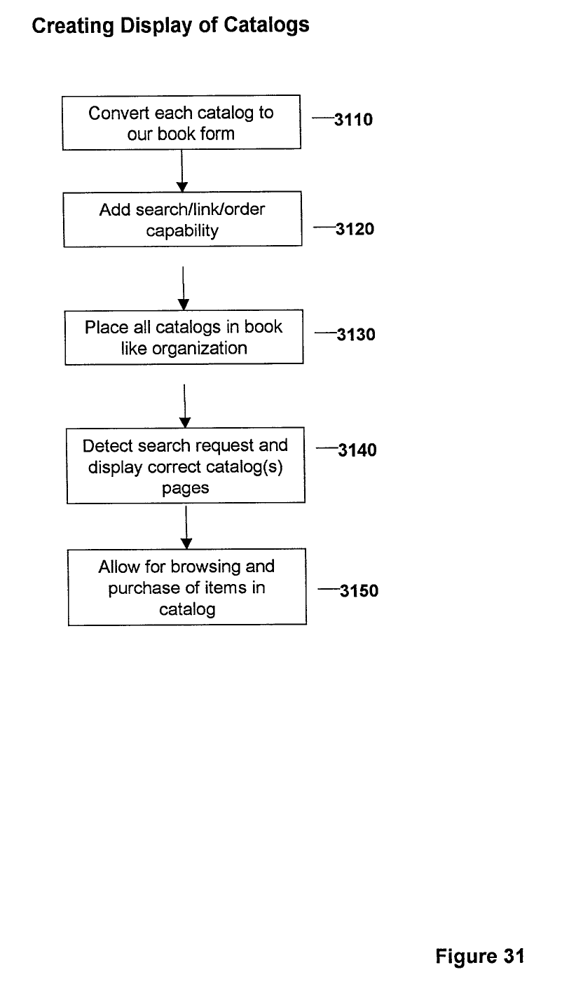

It is well known that while the Internet database based catalogs are searchable, the printed catalogs are easier for the users to view and order from. In this embodiment of the invention we provide a method that gives the best of both worlds, in a way that is not possible either in the brick and mortar store or with the existing models of e-commerce stores. Our process presents a catalog room wherein can be found various catalogs organized by various categories such as clothing, furniture, electronics etc. This represents a huge mall in book form, all available right on the screen, presented in a very concise and intuitive fashion. If the user is looking for a particular item, a search engine will bring up the appropriate page in a particular catalog or can create a brand new catalog of the items found. The user can browse through the results in the all too familiar catalog fashion. The user can also browse through any catalog of choice and order directly from the catalog page. Adding another store is as simple as adding another catalog to a shelf in the room. The catalogs can be updated as often as needed or is possible, and previous catalogs can also be made accessible. All the features of catalog sales such as special sales or event-based catalogs can all be accommodated very easily and very intuitively. Aspects of this embodiment are described in FIG. 31.

Referring now to FIG. 31, each catalog is converted to book form (step 3110) and a search and/or link and/or order capability is coupled to each catalog (step 3120). The catalogs are placed in a book-like organization (step 3130). Search requests are detected and the pages returned from the search are displayed to the user (step 3140); alternatively, users can browse through the catalogs and purchase items (step 3150).

### Creating Corporate Annual Reports

Another embodiment of the invention includes a method for creating and displaying annual reports or other publications of corporations on the Internet.

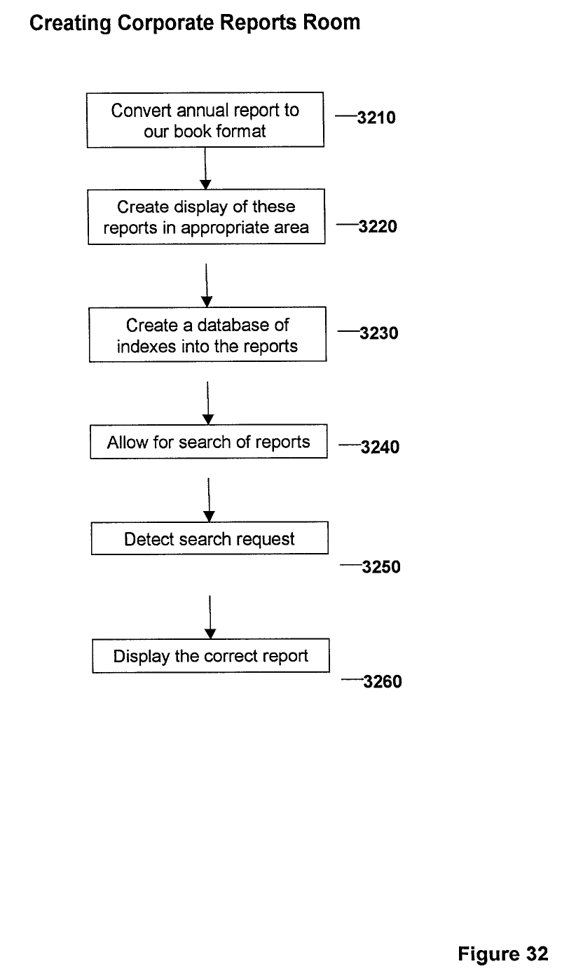

In one embodiment, our method of displaying books on the Internet is easily applicable to creating a library of annual reports or other publications from corporations. In fact, for large corporations, an embodiment of the invention includes a special room or section of the store that displays these publications. All the important publications of companies are now instantly available in a familiar form in a well-organized and intuitive fashion. Reports of prior years can also be made available if a corporation so chooses. A facility to request and receive a printed copy of the report is a natural addition to this powerful “corporate reports room.” Aspects of this embodiment are described in FIG. 32.

Referring now to FIG. 32, a method in accordance with one embodiment of the invention can include converting annual reports to book format (step 3210) and creating a display of these reports in an appropriate area (step 3220). The method can further include creating a database of indexes for the reports (step 3230) to allow for searches of and for the reports (step 3240). A search request is detected (step 3250) and the report returned by the search is displayed to the user (step 3260).

### Specialized Libraries

Another embodiment of the invention includes a method to create specialized libraries on the Internet such as a Legal Library.

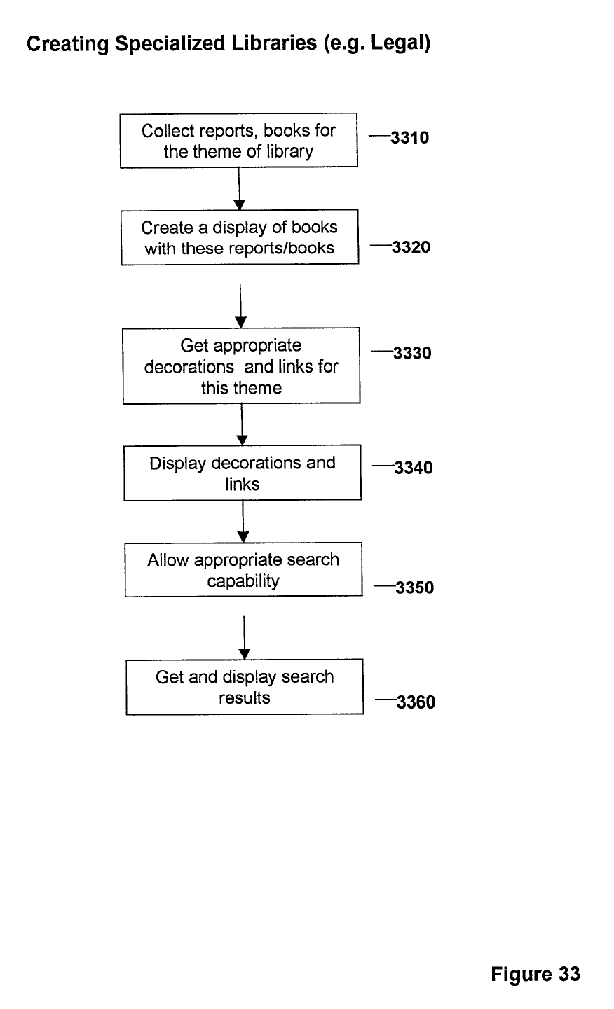

In one embodiment, our method of displaying books on the Internet is well suited to create specialized libraries of any type of books or research reports that are easily accessible on-line, with no real limitation of the number of books or reports that can be carried. Each user can create a library of his own by culling books or reports out of several specialized libraries. Aspects of this embodiment are described in FIG. 33. In one aspect of this embodiment, reports, books, and/or other materials corresponding to a particular theme for a library are collected (step 3310) and displayed to the user (step 3320). Appropriate decorations and links corresponding to the theme are retrieved (step 3330) and displayed (step 3340) while allowing for searching the materials corresponding to the theme (step 3350). The results returned by the search are then displayed to the user (step 3360)

### Videos Display

Another embodiment of the invention includes a method to display videos of movies and shows in an intuitive real-store like fashion a la books.

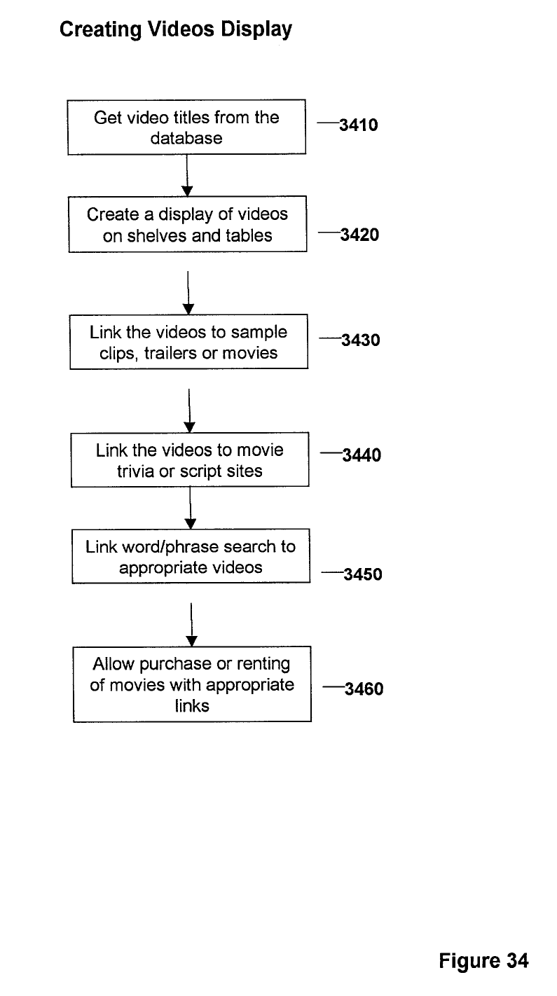

Similar to books, we can also display videos on the shelves and tables in our virtual store. Here again, the movies can be tapes or DVDs or in other format, and can be accompanied by samples such as a streaming video trailer. Links can be placed to movie sites or movie trivia sites or movie script sites or databases, and a search for words or phrases can bring up the corresponding movie. Movies can be sold either on the site or through links with partners. A personal movie area can store the purchased, seen, want to see, or view later selections of specific customers. Aspects of this embodiment are described in FIG. 34.

Referring now to FIG. 34, video titles are obtained from a database (step 3410) and a display of the videos (such as on shelves and/or tables) is created and made available to the user (step 3420). The videos are linked to sample clips, trailers, movies and/or other relevant materials (step 3430) such a movie trivia or script sites (step 3440). Word and phrase search terms can also be linked to appropriate videos (step 3450) and users can purchase or rent the movies using appropriate links (step 3460).

### CD Room

Another embodiment of the invention includes a method to display CDs as in a real world CD store.

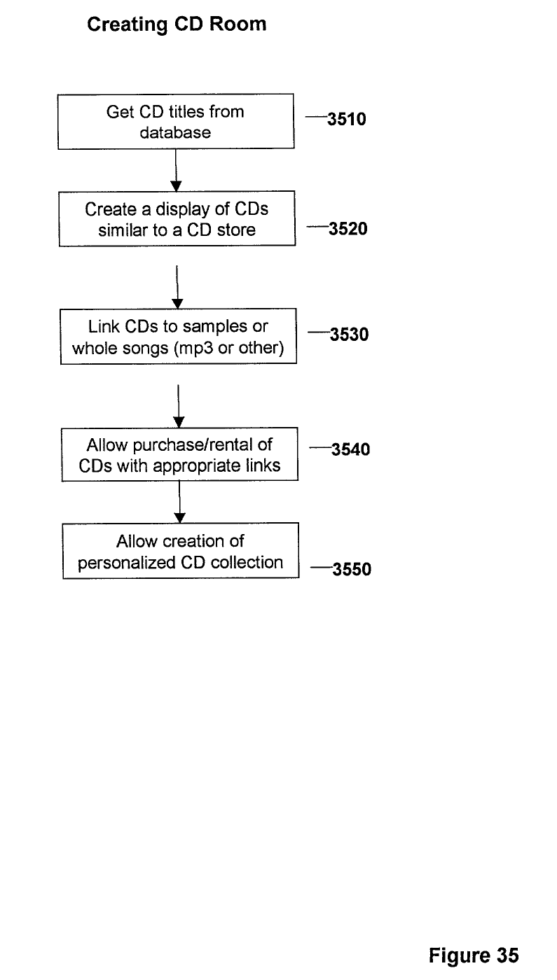

Similar to books, we can also display CDs in a manner akin to those in a real world display. Here too, a personal area can store all CDs of personal interest, including digital versions (MP3 or other) of purchased songs or samples. Aspects of this embodiment are described in FIG. 35. In one aspect of this embodiment, CD titles are obtained from a database (step 3510) and the CDs are displayed to the user in an arrangement similar to that of a conventional bricks and mortar CD store (step 3520). The CDs can be linked to samples or entire songs (for example, using MP3 or other utilities) in step 3530 and users can purchase and/or rent CDs by using appropriate links (step 3540). The method can also include creating a personalized CD collection corresponding to specific requests and/or preferences of the user (step 3550).

### Video Library

Another embodiment of the invention includes a method to collect, store and display special interest videos such as travel videos, health videos or informational videos.

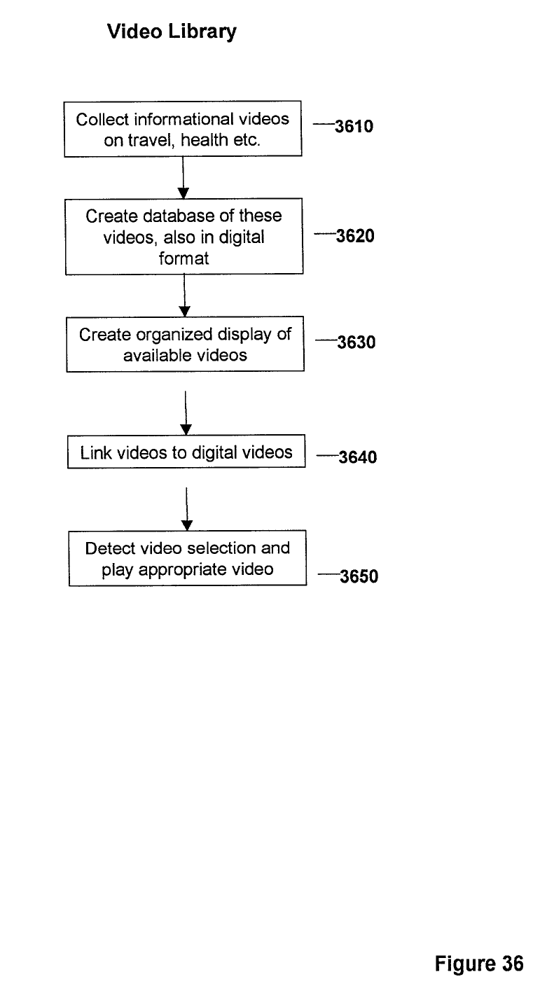

The current displays of videos on the Internet are limited to lists of videos. In one embodiment, our method allows a visual display on a shelf or table and allows for very intuitive browsing of the videos. The video library section collects and displays all informational videos, travel videos, or government sponsored videos that will be of general or specific interest. Aspects of this embodiment are described in FIG. 36.

In one aspect of this embodiment, informational videos on travel, health, and/or other topics are collected (step 3610) and a digital format database corresponding to these videos is created (step 3620). An organized display of the available digital videos is created (step 3630) and the digital videos can be linked to conventional videos (step 3640). When a user selects a particular video, this event is detected and the appropriate video is played to the user (step 3650).

### Book Club Displays

Another embodiment of the invention includes a method to display collections of book clubs in an intuitive way.

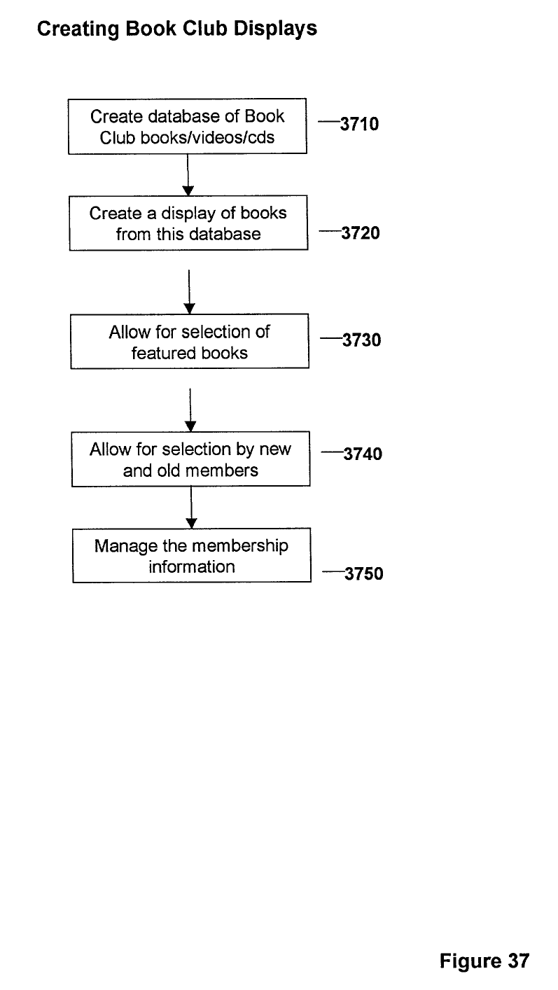

The collections of books that the book clubs send out to their members can be done in a pleasurable way by using the real bookstore like display that we have invented. Aspects of this embodiment are described in FIG. 37. In one aspect of this embodiment, a database of book club videos, books, and/or CDs is created (step 3710) and a display corresponding to materials in the database is created (step 3720). Featured books (and/or other materials) can be selected (step 3730) and new members can be added to the club, for example, by old members (step 3740). Information pertaining to the membership of the club is managed, for example, to include the addition of new members (step 3750).

### Collection of Data and Statistics

Another embodiment of the invention includes a method to collect data about the visitors to the various parts of the store.

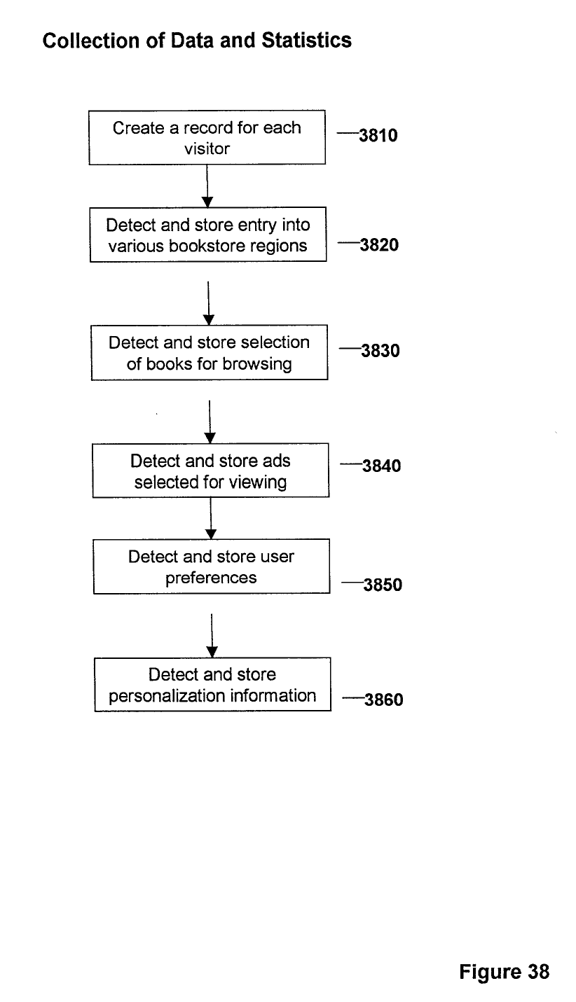

We have invented a method whereby the activities of a visitor to our store can all be collected in a database. Aspects of this embodiment are described in FIG. 38. In one aspect of this embodiment, a record is created for each visitor to the store or the site (step 3810). The method can include detecting and storing information pertaining a visitor's entry into the store and into various regions of the store (step 3820), and can also include detecting and storing information pertaining to the visitor's selection of books for browsing (step 3830). The method can further include detecting and storing ads selected by the visitor for viewing during the visit (step 3840) and detecting and storing other user preferences (step 3850). Personalization information individual to each visitor is detected and stored for later access (step 3860).

### Customer's Private Room

Another embodiment of the invention includes a method for creating private collections for customers with ability to share parts of the collection.

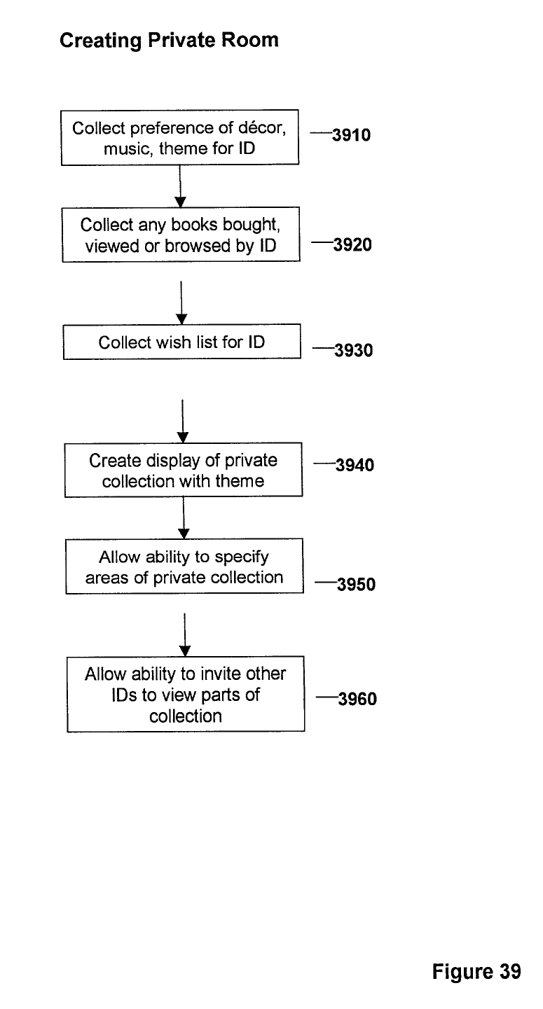

We have invented a method whereby a customer can specify all the books, videos, CDs, reports etc. that he would like to be placed in a private room that is visible only to him. This is equivalent to a private collection. All the books the customer views, buys or browses can all go into this collection. The customer can include in this collection any of the books he wishes to buy or ones he wishes to win as awards for viewing ads. He can allow access to parts of this room to others by means of a password. Aspects of this embodiment are described in FIG. 39.

Referring now to FIG. 39, in one embodiment the method can include collecting preferences for decor, music, a theme, and/or other information for identification (step 3910) and books bought, viewed or browsed by an individual visitor can be collected (step 3920) and a wish list for the visitor can be collected or compiled (step 3930). From the above information, a display of a private collection with a theme tailored to the visitor can be created (step 3940) and visitors can specify particular areas of the private collection they wish to visit (step 3950). Visitors can also invite other visitors to view parts of or the entire personal collection (step 3960).

### Use of Special Document Compression Tools in Virtual 3-D

Another embodiment of the invention includes a method to combine tools such as DjVu available for specialized compression of documents with 3-D virtual reality tools to provide a fast, explorable, 3-D environment.

We have invented a method whereby a 3-D virtual reality world can be decorated with various textures or can contain goods with various textures (e.g., books with spine or cover art or photographs) that would make them rich in visual experience, at the same time reducing the length of the download time by using compression techniques specifically designed for documents such as DjVu.

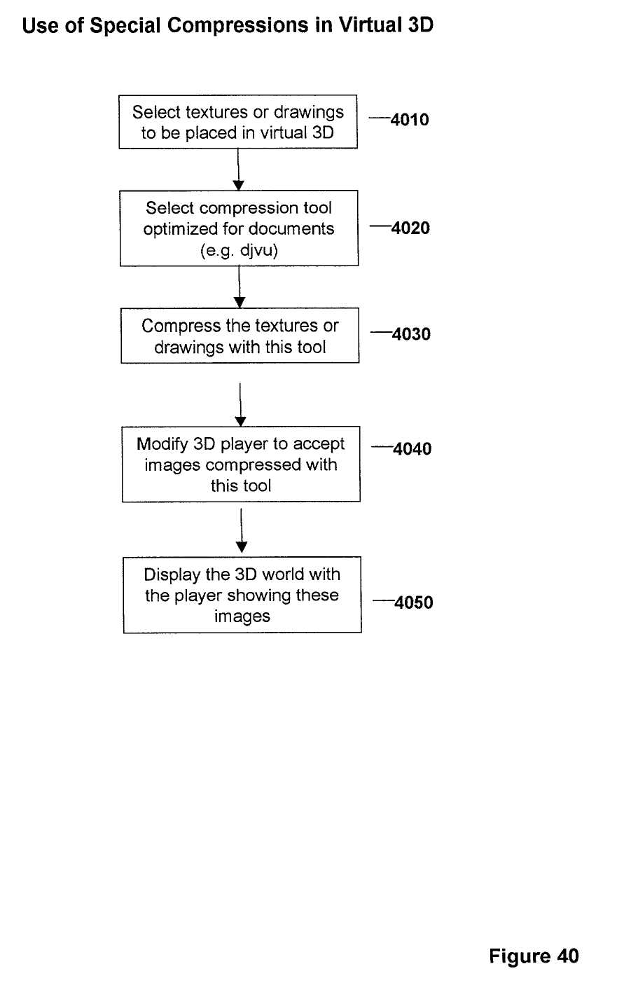

Aspects of an embodiment of a method for using compression techniques specially designed for documents within a 3-D virtual reality tool (player) are shown in FIG. 40. In step 4010, textures or drawing to be placed in the 3-D world are collected. These could be paintings on the wall such as in an art gallery display or a museum or they could be textures of book covers. All these media fall under the description of a document. In step 4020, a compression technique such as DjVu that is specially designed for documents is selected. In step 4030, the textures, drawings and/or other documents are compressed with this tool. If the 3-D player does not accept the image data compressed with the selected compression technique, the 3-D player is modified to work with images compressed with this tool (step 4040). This essentially involves enabling the 3-D player to uncompress such images. In step 4050, the virtual 3-D world is displayed with these images. Accordingly, one aspect of the invention is a new application of specialized compression techniques to a new business process.

### Poetry or Book Audio on Demand

Another embodiment of the invention includes a method to specify a schedule for on-line audio of book content, and to play the same as per the schedule.

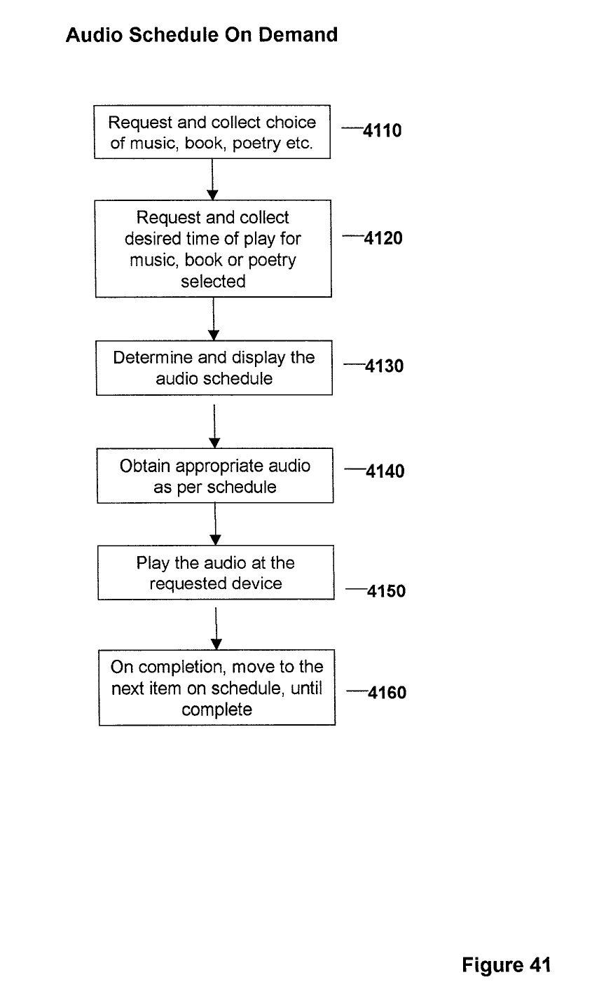

We have invented a method whereby a user can select from among various items of poetry, music, book “trailer” audio, book audio or other audio and place them on a schedule that can be played to him on his device of choice in accordance with his specified schedule. This is like a truly personalized radio that includes, in addition to music, book reviews, author interviews, book audios, poetry readings etc. Aspects of this embodiment are shown in Illustration 20 and described in FIG. 41.

FIG. 41 describes a method to create and play a schedule of audio programs including book readings, book reviews, music, poetry etc. in accordance with an embodiment of the invention. In step 4110, a choice of music, book, poetry or other audio program is requested and obtained from a specific user. Each user can have his or her own “playlists” as well as several schedules. For each selection of music, book or poetry, step 4120 requests and collects the desired time of play. In step 4130, the audio schedule is displayed. Overlaps and schedule conflicts can be interactively corrected. In step 4140, the beginning time of the schedule is detected and the audio data are collected from the appropriate database. In step 4150, the device selected for the audio play is detected and the audio data are directed to and played on that device. In step 4160, the remaining audio data on the schedule are played until the scheduler is complete.

### Sheet Music Helper

Another embodiment of the invention includes a method to deliver user controllable sheet music reader on-line.

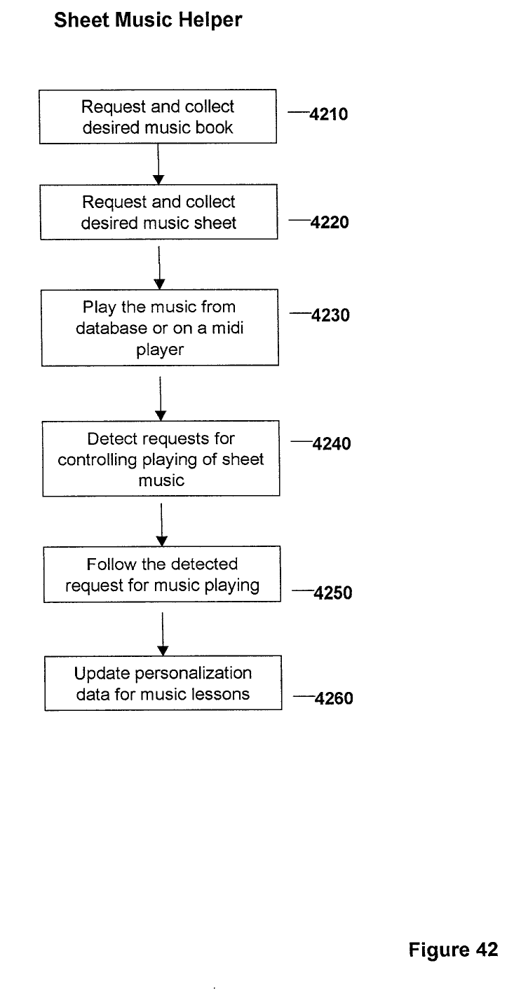

We have invented a method whereby a user can request music from a sheet music book to be played even as the sheet of music is displayed on the screen and the note being played is highlighted. The user can control the progress of the sheet music playing. Of course, the addition of beats, background music etc. would render the learning experience much richer and enjoyable. Aspects of an embodiment of this method are shown in Illustration 21 and described in FIG. 42.

FIG. 42 describes a method for displaying and playing sheet music on-line with the playing controlled by the user in accordance with an embodiment of the invention. In step 4210, the desired music book is requested and collected. In step 4210, the specific sheet of music desired is requested and collected. The music piece is obtained from an appropriate database in an appropriate format. In step 4230, the music is played on the user's on-line device or an associated midi player. Requests for controlling the music, such as stopping, continuing or going back a measure are collected in step 4240, and these requests are followed in step 4250. All the personalization details of the sheet music experience for the particular user such as a “book mark,” the types of music desired or where he is in some specific music lesson sequence are all updated in step 4260.

### Artist's Room

Another embodiment of the invention includes a method to enable artists and others to create rooms or displays of their work that can be accessed by others.

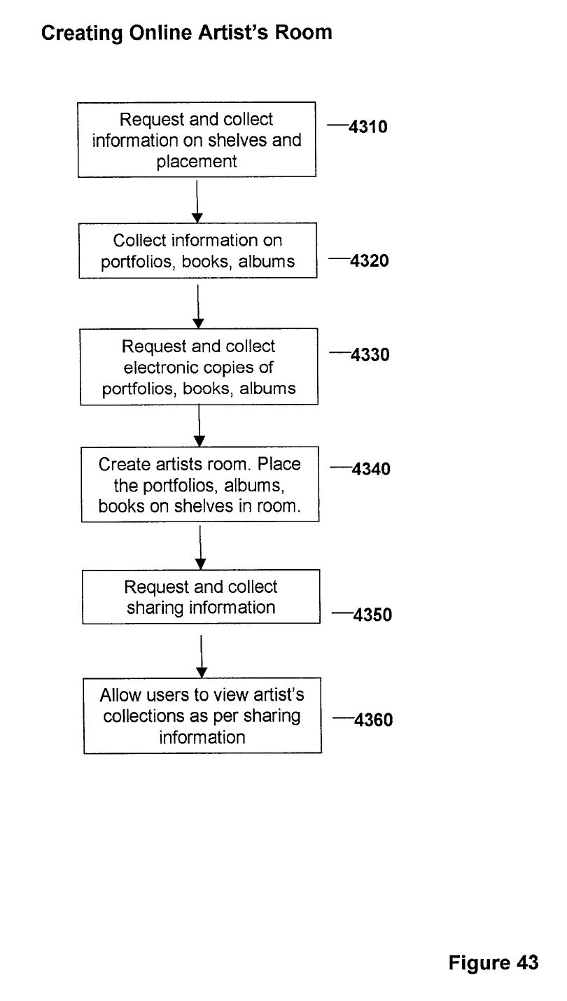

We have invented a method whereby any kind of writing, painting etc. can be preserved and displayed in an organized fashion and offered for viewing by visitors with different levels of security—personal, close friends and family, public etc. An artist's portfolio, a budding writer's books, a family's photo album are all possible to be displayed in this paradigm. Aspects of an embodiment of this method are described in FIG. 43.

FIG. 43 describes an embodiment of a method to create a special room for artists and others where they can store, organize and display their work on-line. In step 4310, the details such as placement of shelves, wall hangings and other decorations, or the lighting in the virtual room are requested and collected from the user. Then in step 4320, all the details of the portfolios, books or albums the user may wish to place in the virtual artist's room are collected. In step 4330 the electronic versions of these items are requested and obtained. Instructions for scanning could be displayed if necessary. In step 4340, the artist's room is created using the foregoing information. All the portfolios, albums and books specified by the user are placed on the shelves or tables as requested, with the possibility of interactive changes. These albums, books or portfolios can be shared with members of family, friends or public at large. This is achieved by using several levels of security. The sharing information (for example, information pertaining to who has access to each piece of work) is requested and collected in step 4350, and the display is updated accordingly. A distinct and well-arranged display can be created for each category. When other users are logged in, and enter the artist's room, they are shown the albums, books or portfolios according to the sharing information in step 4360.

### Grocery Embodiment

Another embodiment of the invention includes a method for recreating the essential features of a real grocery store and augmenting it with computer capabilities in a way that makes the chore of grocery shopping easy, and even pleasurable; a method for adding value added services to the groceries and grocery store on-line. There are several important features that characterize a typical grocery bricks and mortar store.

For example, a typical bricks and mortar grocery store includes a huge variety of items displayed all at once. Accordingly, a visitor to the grocery store is presented with a bright array of aisles and quite a variety of attractive items on tables all around. The items are organized into easily identifiable categories, which are logically divided into aisles. Users can easily walk through the aisles to quickly retrieve the items they need by navigating through the store in an intuitive fashion. Accordingly, the users can become so familiar with the store that they can go to the proper section sometimes without even having to look at the aisle labels. For example, the users know where the dairy products are, where they can find the breads or what aisle will have fresh vegetables.

Another feature of bricks and mortar grocery stores is that they can support impulse buying. For example, most visitors to the grocery store arrive with a list (mental or written) of items to buy, and most of the time they also buy items that are not on the list, thanks to the merchandizing ability of the store. This includes impulse items specially placed at the check out counters for this very purpose. Visitors to the bricks and mortar grocery store can also find non-grocery items such as shampoo, over the counter drugs, prescription drugs, cleaning supplies, stationery, greeting cards, and even some books. If the visitors need help, they can easily find helpful employees walking or working in the aisles that can answer questions about the items in the aisles or direct the visitor to the proper aisle to locate an item.

Furthermore, the typical bricks and mortar store can provide the visitor with a social experience. For example, visitors to the grocery store meet and greet other visitors who could also give recommendations on items to buy or can answer questions on how to use a specialty item such as an exotic vegetable that they are buying.

One drawback with conventional grocery stores is long lines at the check out counters. This is a very familiar sight to most visitors to the grocery store, almost at any time of day or night, but especially at “rush” hours.

The current on-line grocery stores lack many of the features of a bricks and mortar store, although they offer other conveniences, such as 24-hour opening or at home shopping. Although typical on-line grocery stores provide some advantages (for example, short or non-existent check-out lines, and a theoretically larger number of items in an on-line grocery store because of the lack of physical limitations), these on-line stores also suffer from several drawbacks. For example, the items in typical on-line grocery stores are divided into logical categories, but they are not easily identifiable.

The huge variety of items are typically displayed in endless scrolling lists, which can be cumbersome. For example, the milk category brings up a list of 25 to 50 varieties of milk of different sizes, fat content, or brands, making it difficult to select the right kind. Some of the sites provide a picture of the milk cartoon, but only for one item at a time. Accordingly, it can be difficult for the user to perform a surgical search for a specific item.

Existing on-line grocery stores suffer from several other drawbacks as well. For example, the social experience is missing, with neither helpful employees nor other visitors anywhere on the scene. Impulse buying is missing. The merchants cannot use on-line the experience they have gained through the years in merchandizing in a bricks and mortar store. All they can do is to tell the programmers what items to place on different lists leading to an experience which neither the merchant nor the consumer cherish.

One objective of our invention is to create an on-line grocery store that creatively combines all the desirable features of a real grocery store with the capabilities of the computer and the Internet in a way that makes the chore of grocery shopping easy and quick, and perhaps even a pleasurable experience. Accordingly, in one embodiment, our on-line grocery store can be the store of choice for visitors, with fixed and easy to find categories in familiar aisle-shelf format of a real grocery store. The store can add to the convenience and experience by taking advantage of the computer/Internet. In one embodiment, the method can include making grocery shopping a totally personalized service. For example, a store can be built in the visitor's image, with his preferences, dietary restrictions, culinary exploratory interests, etc. In another embodiment, the store can show the visitor recipes and prepared items that fit his profile, and can warn him if he puts in his shopping carts things that don't fit his profile. The store can create totally new lines of business; for example, greeting cards sent automatically based on visitor's prior request, flowers shipped nationwide, fruit baskets, cookie baskets and other gift baskets, recipes on-line, and/or recipe ingredient orders on-line. In other embodiments, the on-line grocery store can have other features and, as described above, similar methods can be applied to other commercial settings.

[image]

[image]

[image]

[image]

[image]

[image]

[image]

[image]

[image]

[image]

[image]

[image]

[image]

[image]

[image]

[image]

[image]

[image]

[image]

[image]

[image]

1. A method for displaying information on a visual display to simulate a three-dimensional arrangement, the method comprising:
depicting graphical representations of products in a virtual three dimensional environment that simulates a brick-and mortar store;
whereby a user may navigate within the environment and click upon individual products to focus on the individual product.

2. The method of claim 1, wherein the products are books arranged in a three dimensional graphical representation of a brick-and-mortar book store.

3. The method of claim 2 whereby the user may hear an audio rendition of the book.

4. The method of claim 1 further comprising:
searching for particular products using search criteria;
organizing the products into categories; and
depicting the results of the search according to the categories in the virtual three dimensional environment;

5. The method of claim 4 further comprising the step of:
recategorizing the products; and
displaying the products within the virtual three dimensional environment according to the recategorization.

6. The method of claim 1 wherein a user may obtain assistance regarding the product by accessing a three dimensional depiction of an information counter or help desk.
